(19) United States
(12) Patent Application Publication
(10) Pub. No.: US 2025/0111007 A1
(43) Pub. Date: Apr. 3, 2025

(54) ACCELERATED FFT HARDWARE

(71) Applicant: Texas Instruments Incorporated, Dallas, TX (US)

(72) Inventors: Kanish B, CHENNAI (IN); Karthik Subburaj, Bangalore (IN); Karthik Ramasubramanian, Bangalore (IN); Anushree Pendharkar, Bangalore (IN); Kameswaran Vengattaramane, Bangalore (IN); Atman Kar, Bangalore (IN)

(21) Appl. No.: 18/901,256

(22) Filed: Sep. 30, 2024

(30) Foreign Application Priority Data
Oct. 3, 2023 (IN) 202341066179

(51) Int. Cl. G06F 17/14; G06F 7/50; G06F 7/523

(52) U.S. Cl. CPC G06F 17/142; G06F 7/50; G06F 7/523

(57) ABSTRACT

In described examples, an integrated circuit (IC) includes a fast Fourier transform (FFT) engine, a first memory, a second memory, a conjugate symmetric combiner (CSC), and a control circuit coupled to control them. The first and second memories are coupled to the FFT engine, and the CSC is coupled to the first and second memories and the FFT engine. The FFT engine receives and processes a first stream of samples to generate a second stream of samples. In a first phase, the FFT engine provides a first portion of the second stream of samples to the first memory. In a second phase, the FFT engine provides a second portion of the second stream of samples to the second memory, the first memory provides the first portion of the second stream of samples to the CSC, and the CSC responsively generates a third stream of samples.

### CROSS-REFERENCE TO RELATED APPLICATION

This application claims the benefit of and priority to India Provisional Application No. 202341066179, filed Oct. 3, 2023, which is incorporated herein by reference.

### TECHNICAL FIELD

This patent application relates generally to hardware acceleration for fast Fourier transforms (FFTs), and in particular, to a hardware accelerator for performing real-valued FFTs.

### BACKGROUND

A real FFT transforms a real-valued input sequence, such as real-valued data samples, into complex-valued spectral estimate information. A complex FFT transforms a complex-valued input sequence, such as complex-valued data samples, into complex-valued spectral estimate information. Example applications for real-valued and complex-valued FFTs include frequency modulated continuous wave (FMCW) radar, audio and speech processing, bio-signal processing, telecommunications, and other sensor signal processing contexts.

### SUMMARY

In described examples, an integrated circuit (IC) includes a fast Fourier transform (FFT) engine, a first memory, a second memory, a conjugate symmetric combiner (CSC), and a control circuit coupled to control them. The first and second memories are coupled to the FFT engine, and the CSC is coupled to the first and second memories and the FFT engine. The FFT engine receives and processes a first stream of samples to generate a second stream of samples. In a first phase, the FFT engine provides a first portion of the second stream of samples to the first memory. In a second phase, the FFT engine provides a second portion of the second stream of samples to the second memory, the first memory provides the first portion of the second stream of samples to the CSC, and the CSC responsively generates a third stream of samples.

### BRIEF DESCRIPTION OF THE DRAWINGS

FIG. 1 is a functional block diagram of an example radar system for transmitting a radar signal and receiving a reflected radar signal.

FIG. 2 is a set of graphs illustrating an example process for determining range and velocity using FMCW signals, such as FMCW chirps, transmitted and received by the FMCW radar system of FIG. 1.

FIG. 3 is a set of graphs illustrating an example process for determining angle using range-Doppler FFTs.

FIG. 4 is a flow diagram of an example process for determining range, velocity, and angle of arrival using data samples generated by the receiver signal chain of FIG. 1.

FIG. 5 is a functional block diagram of a first example system for selectably determining a real FFT or a complex FFT.

FIG. 6A is a functional block diagram of a second example system for selectably determining a real FFT or a real inverse FFT (“IFFT”).

FIG. 6B is a functional block diagram of a third example system for selectably determining a real FFT or a real IFFT.

FIG. 7 is a functional block diagram of an example system for selectably determining a real FFT, a real inverse FFT, a complex FFT, or a complex IFFT.

FIG. 8 is a functional block diagram of an example implementation of the conjugate symmetric combiner of FIGS. 5, 6A, and 6B.

FIG. 9 is a set of example input samples provided by the FFT engine of FIG. 6A to be processed by the conjugate symmetric combiner of FIGS. 5 and 6A to determine an FFT of the input samples using a radix-2 approach.

FIG. 10 is a functional block diagram of an example system for selectably determining a real FFT, a real inverse FFT, a complex FFT, or a complex IFFT.

FIG. 11A is a functional block diagram of a view of the system of FIG. 10 corresponding to a first phase in a first iteration of an example radix-2 process for determining an N-point real FFT.

FIG. 11B is a functional block diagram of a view of the system of FIG. 10 corresponding to a second phase of the example radix-2 process for determining an N-point real FFT.

FIG. 11C is a functional block diagram of a view of the system of FIG. 10 corresponding to the third phase of the example radix-2 process for determining an N-point real FFT.

FIG. 11D is a functional block diagram of a view of the system of FIG. 10 corresponding to the fourth phase of the example radix-2 process for determining an N-point real FFT.

FIG. 11E is a functional block diagram of a view of the system of FIG. 10 corresponding to the first phase in second and later iterations of the example radix-2 process for determining an N-point real FFT.

FIG. 12A is a table showing example input samples, contents of the ping buffer, contents of the pong buffer, a combiner control signal, output samples, and a clock signal, corresponding to the process of FIGS. 11A through 11E.

FIG. 12B is a continuation of the table of FIG. 12A.

FIG. 13 is a flow diagram of an example radix-2 process for determining an N-point real FFT.

FIG. 14 is a functional block diagram of a fourth example system for selectably determining a real FFT or a complex FFT.

FIG. 15 is a set of example input samples provided by the FFT engine of FIGS. 6A and 14 to be processed by the conjugate symmetric combiner of FIGS. 6A and 14 to determine an FFT of the input samples using a radix-3 approach.

FIG. 16A is a functional block diagram of a view of the system of FIG. 10 corresponding to a first phase in a first iteration of an example radix-3 process for determining a 3N-point real FFT.

FIG. 16B is a functional block diagram of a view of the system of FIG. 10 corresponding to a second phase of the example radix-3 process for determining a 3N-point real FFT.

FIG. 16C is a functional block diagram of a view of the system of FIG. 10 corresponding to a third phase of the example radix-3 process for determining a 3N-point real FFT.

FIG. 16D is a functional block diagram of a view of the system of FIG. 10 corresponding to a first phase in a second or later iteration of the example radix-3 process for determining a 3N-point real FFT.

FIG. 17A is a table showing example input samples, contents of the ping buffer, contents of the pong buffer, a combiner control signal, output samples, and the clock signal (CLK), corresponding to the process of FIGS. 16A through 16D.

FIG. 17B is a continuation of the table of FIG. 17A.

FIG. 18 is a flow diagram of an example radix-3 process for determining a 3N-point real FFT.

FIG. 19 is a set of input samples 1900 to be processed by the conjugate symmetric combiner 516 of FIGS. 5 and 6A to determine a real IFFT of the input samples 1500 using a radix-2 approach.

FIG. 20A is a functional block diagram of a view of the system of FIG. 10 corresponding to a first phase 2000a(1) in a first iteration of an example radix-2 process for determining an N-point real IFFT.

FIG. 20B is a functional block diagram of a view of the system of FIG. 10 corresponding to a second phase 2000b of an example radix-2 process for determining an N-point real IFFT.

FIG. 20C is a functional block diagram of a view of the system of FIG. 10 corresponding to a first phase of a second or later iteration of an example radix-2 process for determining an N-point real IFFT.

FIG. 21A is a table showing example input samples, contents of the ping buffer, contents of the pong buffer, a combiner control signal, output samples (intermediate samples) provided to the conjugate block, and the clock signal (CLK), corresponding to the process of FIGS. 20A through 20C.

FIG. 21B is a continuation of the table of FIG. 21A.

FIG. 22 is a flow diagram of an example radix-2 process for determining an N-point real IFFT.

### DETAILED DESCRIPTION

A complex FFT engine, also referred to herein as an FFT engine, is used to determine a complex FFT using complex-valued samples. In some examples, a serial pipelined complex FFT engine can process one complex-valued sample per clock cycle to produce one FFT output sample. A supplementary processing stage, referred to herein as a combiner stage, is described. Processes for using an FFT engine with the combiner stage enable determining one real-valued FFT output sample per clock cycle in response to one real-valued input sample per clock cycle provided to the FFT engine. The combiner stage can also be used with the FFT engine to determine a real inverse FFT at a rate of one output sample per clock cycle in response to one input sample provided to the system per clock cycle.

Accordingly, an FFT engine can be used with the combiner stage to selectably determine a real FFT, real inverse FFT, complex FFT, or complex inverse FFT. In some examples, the FFT engine and combiner can receive input samples in a first direction to selectably perform a real FFT or a complex FFT, and can receive input samples in a second direction to selectably perform a real IFFT or a complex IFFT.

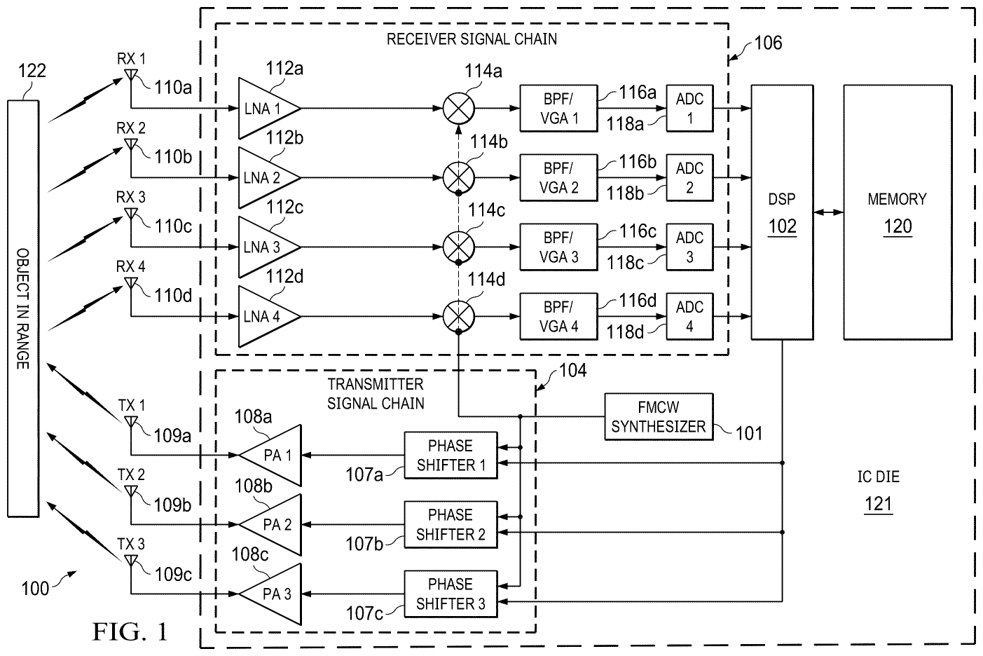

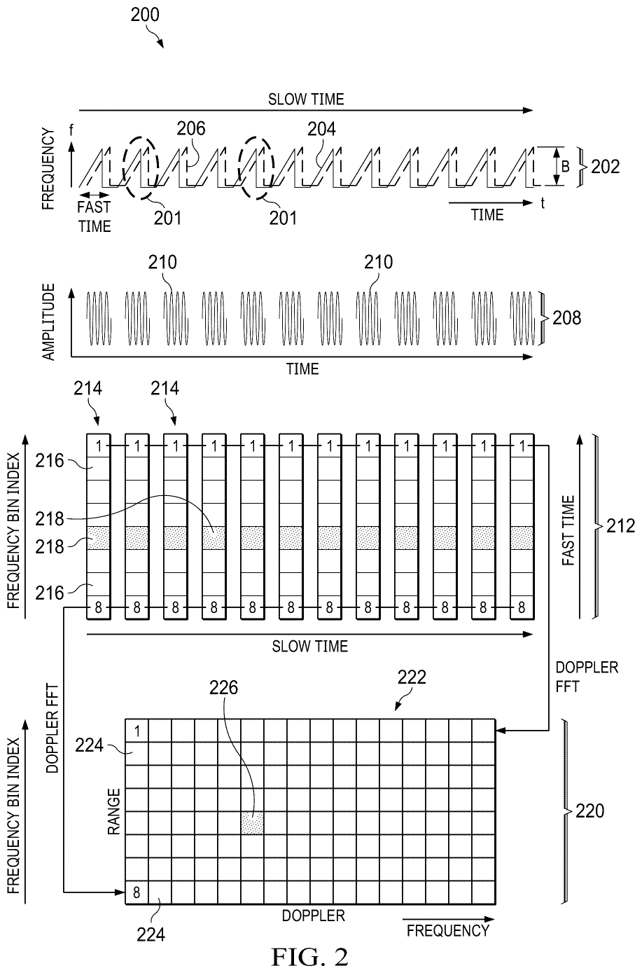

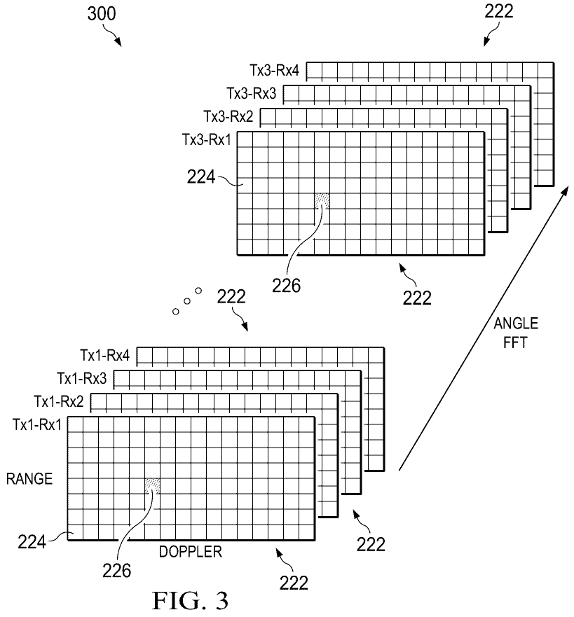

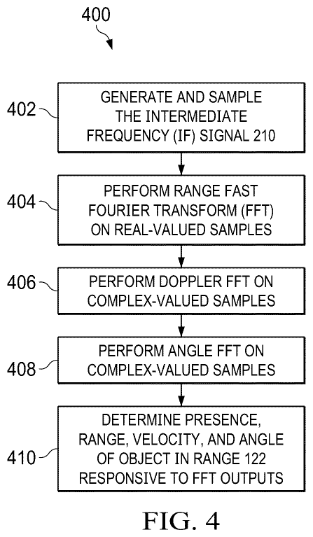

Initially, an application using real-valued and complex-valued FFTs, specifically FMCW radar, is described to provide context. An FMCW radar system is described with respect to FIG. 1. A process for using the FMCW radar system to determine presence, range, velocity, and angle information with respect to objects in range of the FMCW radar system is described with respect to FIGS. 2 and 3. A brief summary of the process is described with respect to FIG. 4 to illustrate use of real-valued and complex-valued FFTs to enable object detection by the FMCW radar system.

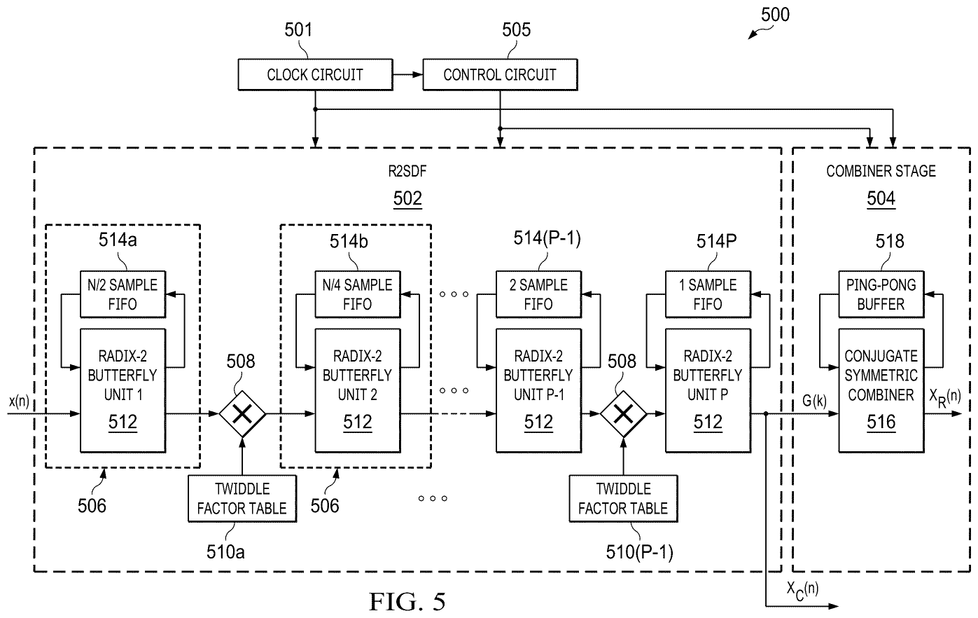

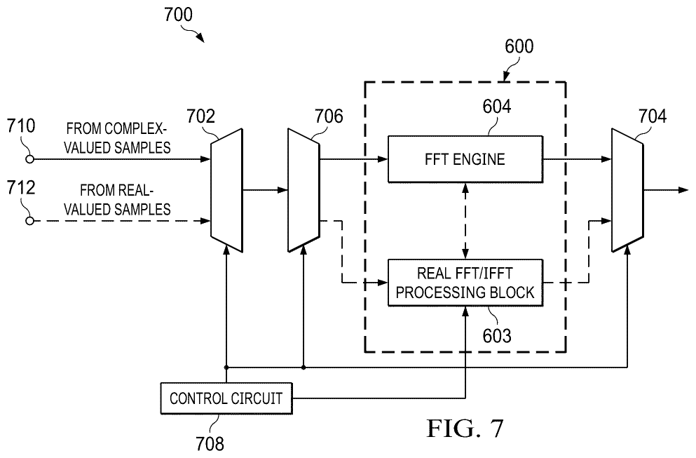

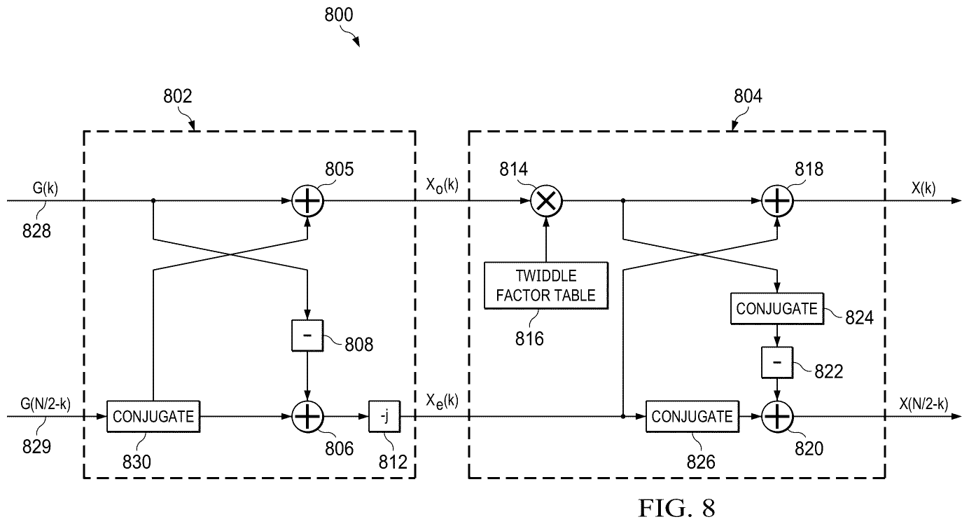

Systems for determining real and complex FFTs, and real and complex inverse FFTs are described with respect to FIGS. 5 through 7, 10, and 14. The combiner stage includes a conjugate symmetric combiner. The conjugate symmetric combiner and a ping-pong buffer are used by the systems described with respect to FIGS. 5 through 7 and 10 to determine a real FFT using output of an FFT engine. The conjugate symmetric combiner is described with respect to FIG. 8.

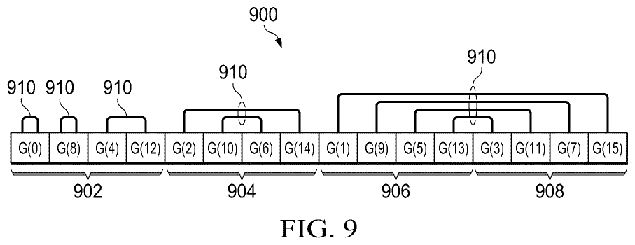

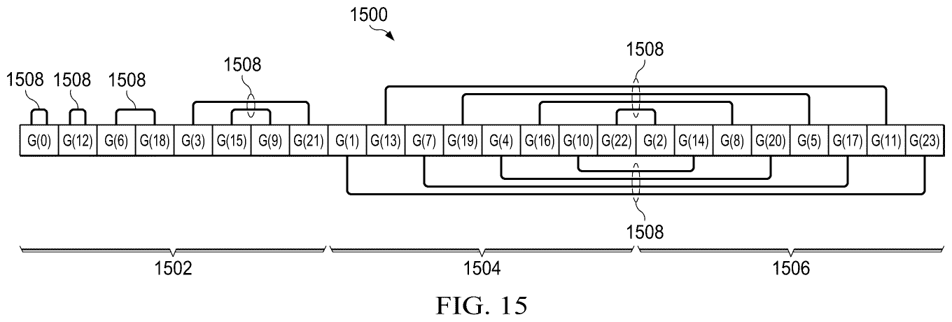

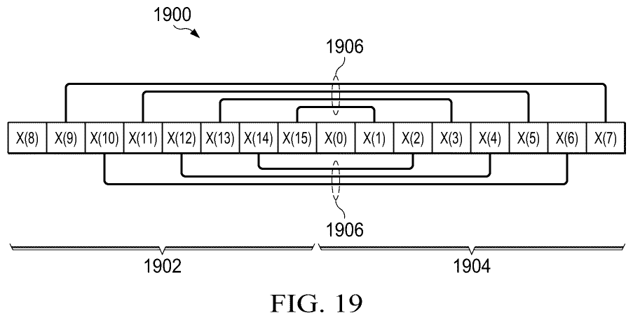

A process for determining a real FFT using a radix-2 approach is described with respect to FIGS. 9 and 11A through 13. A process for determining a real FFT using a radix-3 approach is described with respect to FIGS. 15 through 18. A process for determining a real inverse FFT using a radix-2 approach is described with respect to FIGS. 19 through 22.

Herein, some structures or signals that are distinct but closely related have reference numbers that use a [number][letter] format, such as transmitters 109a, 109b, and 109c, and receivers 110a, 110b, 110c, and 110d. In some examples, these structures or signals are referred to generally, in the singular or as a group, using the [number] and without the [letter], such as the transmitters 109 and the receivers 110. Also, the same reference numbers or other reference designators are used in the drawings to designate features that are closely related structurally and/or functionally.

FIG. 1 is a functional block diagram of an example radar system 100 for transmitting a radar signal and receiving a reflected radar signal. In particular, the radar system 100 is an FMCW radar system. FMCW radar systems transmit a series of “chirps,” which are signals that have frequencies that vary over time, such as a linear ramp up in frequency from a first frequency to a second frequency. Chirps to be transmitted by different antennas of a radar system can be differentiated, using various protocols, to enable a corresponding receiver signal chain to determine which portion of a received signal corresponds to which transmitter antenna. Example differentiation protocols include Doppler division multiple access (DDMA), time division multiple access (TDMA), and Binary Phase Modulation (BPM). Thus in one example, the radar system 100 is a DDMA FMCW radar system.

In some examples, a DDMA FMCW radar system, or an FMCW radar system using another type of transceiver protocol (such as TDMA or BPM), or a different type of radar system, uses different functional blocks. In some examples, the radar system 100 is configured to use millimeter wave sensing or sub-terahertz (sub-THz) sensing. In some examples, the radar system 100 uses millimeter wave sensing that transmits chirps in a 60 gigahertz (GHz) or 77 GHz band. In some examples, the radar system 100 uses sub-THz sensing that transmits chirps in a 140 GHz or higher band.

The radar system 100 includes an FMCW synthesizer 101 (a signal generator), a digital signal processor (DSP) 102, a transmitter signal chain 104, a receiver signal chain 106, transmitter antennas 109, receiver antennas 110, and a memory 120. In some examples, all or a portion of the FMCW synthesizer 101, the DSP 102, the transmitter signal chain 104, the receiver signal chain 106, and the memory 120 are fabricated together on an integrated circuit (IC) die 121.

The transmitter antennas 109 include a first transmitter antenna (TX1) 109a, a second transmitter antenna (TX2) 109b, and a third transmitter antenna (TX3) 109c. The receiver antennas 110 include a first receiver antenna (RX1) 110a, a second receiver antenna (RX2) 110b, a third receiver antenna (RX3) 110c, and a fourth receiver antenna (RX4) 110d.

The FMCW synthesizer 101, which may include an oscillator and a phase locked loop, may be configured to generate radar-frequency signals such as chirps, signals with linearly increasing or decreasing frequency. These signals may be provided by the FMCW synthesizer 101 to the transmitter signal chain 104. The transmitter signal chain 104 includes phase shifters 107 and power amplifiers 108. The transmitter signal chain 104 can also be described as including the FMCW synthesizer 101. The phase shifters 107 include a first phase shifter (phase shifter 1) 107a, a second phase shifter (phase shifter 2) 107b, and a third phase shifter (phase shifter 3) 107c that each independently shift the phase of a respective copy of the signal provided by the FMCW synthesizer 101. The power amplifiers 108 include a first power amplifier (PA1) 108a, a second power amplifier (PA2) 108b, and a third power amplifier (PA3) 108c.

The receiver signal chain 106 includes low noise amplifiers (LNAs) 112, mixers 114, band pass filter (BPF) and variable gain amplifier (VGA) circuits (BPF/VGA circuits) 116, and analog-to-digital converter (ADC) circuits 118. The receiver signal chain 106 can also be described as including the FMCW synthesizer 101.

The LNAs 112 include a first LNA (LNA1) 112a, a second LNA (LNA2) 112b, a third LNA (LNA3) 112c, and a fourth LNA (LNA4) 112d. The mixers 114 include a first mixer 114a, a second mixer 114b, a third mixer 114c, and a fourth mixer 114d. The BPF/VGA circuits 116 include a first BPF/VGA circuit (BPF/VGA 1) 116a, a second BPF/VGA circuit (BPF/VGA 2) 116b, a third BPF/VGA circuit (BPF/VGA 3) 116c, and a fourth BPF/VGA circuit (BPF/VGA 4) 116d. The ADC circuits 118 include a first ADC circuit (ADC 1) 118a, a second ADC circuit (ADC 2) 118b, a third ADC circuit (ADC 3) 118c, and a fourth ADC circuit (ADC 4) 118d.

The FMCW synthesizer 101 generates chirps to be transmitted, such as for object detection and range, angle, and velocity determination. The FMCW synthesizer 101 outputs the chirps to respective first inputs of the phase shifters 107, and also to first inputs of respective mixers 114. In some examples, the FMCW synthesizer 101 can be described as providing an input to the transmitter signal chain 104, and a first input to the receiver signal chain 106.

The phase shifters 107 phase shift the chirps using respective, differentiated phase shift code vectors to enable DDMA differentiation. The phase shifters 107 output the phase shifted chirps to respective power amplifiers 108. The power amplifiers 108 amplify the respective phase shifted chirp signals and output the amplified signals to respective transmitter antennas 109. In some examples, the transmitter antennas 109 can be described as receiving an output of the transmitter signal chain 104.

The transmitter antennas 109 transmit the amplified, phase shifted chirps. In some examples, the transmitted signals are reflected by an object in range 122 that is within the field of view (FOV) and the detection and range, angle, and velocity determination range of the radar system 100. Herein, object in range 122 refers to an object that is both within a shared FOV of the transmitter antennas 109 and corresponding receiver antennas 110, and within a designed range over which a corresponding radar system (such as the radar system 100 of FIG. 1) can detect objects using received reflected signals.

The reflected signals are received by the receiver antennas 110. The receiver antennas 110 output the received signals to respective LNAs 112, which amplify the received signals. In some examples, the receiver antennas 110 can be described as providing a second input to the receiver signal chain 106.

The LNAs 112 output the amplified signals to second inputs of respective mixers 114. The mixers 114 output the mixed signals to respective BPF/VGA circuits 116 which filter and amplify the mixed signals. The BPF/VGA circuits 116 output the resulting cleaned signals to respective ADC circuits 118, which sample the cleaned mixed signals to generate respective data sets made up of digital samples. The ADC circuits 118 output the digital samples to the DSP 102 for analysis. In some examples, the DSP 102 can be described as receiving an output of the receiver signal chain 106.

The DSP 102 is programmed according to instructions which, when executed, use the digital samples to determine presence, range, angle, and velocity of the object in range 122. For example, object presence may be determined based on a signal amplitude greater than a threshold. Range may be determined by a unique range frequency corresponding to the signal's round trip delay multiplied by a frequency slope of a transmitted chirp. Velocity may be determined by the phase variation of the unique range frequency over multiple chirps, which manifests as a unique Doppler frequency. Angle may be determined by the phase variation for a particular received chirp across different receiver paths in the receiver signal chain 106, caused by the difference in time of flight across the different receivers. A spectral estimation technique such as an FFT may be applied to the digital samples provided by the ADCs 118 to enable these determinations. These determinations are further discussed with respect to FIGS. 2 and 3.

FIG. 2 is a set of graphs illustrating an example process 200 for determining range and velocity using FMCW signals, such as FMCW chirps 201, transmitted and received by the FMCW radar system 100 of FIG. 1. For step 202, the horizontal axis indicates time, and the vertical axis indicates frequency. For step 208, the horizontal axis indicates time, and the vertical axis indicates amplitude. In step 202, an FMCW signal 204 is transmitted, and a received FMCW signal 206 is received. A pulse repetition interval (PRI) is the time from the beginning of one transmitted FMCW chirp 201 to the beginning of the next FMCW chirp 201 transmitted by the same transmitter 109. Fast time corresponds to an individual PRI with respect to a corresponding one of the transmitters 109. Individual FMCW chirps 201 are transmitted and received in fast time. The FMCW signal 204 is transmitted, and the received FMCW signal 206 is received, in slow time, corresponding to a sequence of PRIs.

The amount of time for a signal transmitted by the transmitters 109 to reach the object in range 122 equals d. The time for the reflected signal to return from the object in range 122 and be received by the receivers 110 also equals d. Accordingly, the time of flight of an FMCW chirp 201 reflected by the object in range 122 is 2d. In some examples, the value of d varies in response to the distinct locations of different ones of the transmitters 109 and/or the distinct locations of the receivers 110. This varying value of d manifests in the signals received by the different receivers 110 as a phase variation that is used to perform angle estimation. Received FMCW chirps 201 are Doppler shifted relative to corresponding transmitted FMCW chirps 201. An angle of this phase shift depends on motion of the FMCW radar system 100 relative to the object in range 122 from which the received FMCW chirps 201 are reflected, and on phase shift applied by a corresponding one of the phase shifters 107.

In step 208, the mixers 114 mix (for example, multiply) respective received signals 206 with the FMCW signal 204 generated by the FMCW synthesizer 101 to produce intermediate frequency (IF) signals 210. Accordingly, the IF signal 210 is the product of mixing the received signal 206 with the transmitted signal 204. The frequency of the IF signal 210 is linearly proportional to the time of flight, 2d, of the corresponding FMCW chirp 201. As described with respect to FIG. 1, the ADCs 118 sample these IF signals 210 after they are cleaned and amplified, and provide the resulting digital samples to the DSP 102 for analysis.

In step 212, the DSP 102 performs an FFT on sets of the digital samples in fast time. This means that FFTs are determined for sets of samples of IF signals 210 (received signals mixed with transmitted signals), so that the sets of samples are aligned to respective PRIs. This produces a series of one-dimensional range FFTs 214 that are sequential in time. Successive sets of range FFTs 214, each corresponding to a duration in slow time, are used to make successive object detection determinations of presence, range, velocity, and angle of objects in range 122 for the corresponding duration. Each such duration, corresponding to a set of range FFTs 214 covering a respective set of PRIs, is referred to as a frame. The duration of a frame corresponds to a number of PRIs determined in response to a designed velocity resolution.

The range FFTs 214 are divided into frequency bins 216. Each frequency bin 216 covers a separate Doppler shift frequency range and has an index indicating a range to the object and a value indicating a return signal strength associated with the respective range. The number of frequency bins 216 in respective range FFTs 214 corresponds to a frequency resolution of the FMCW radar system 100. Range and velocity resolution of the FMCW radar system 100 are responsive to the frequency resolution of the FMCW radar system 100.

In the illustrated example, there are eight frequency bins 216 in each range FFT 214. In some examples, a range FFT 214 includes hundreds of frequency bins 216. If an object in range 122 is present, over a period of time, to reflect the transmitted FMCW chirps 201, there will be an amplitude spike (peak) 218. The peak 218 is shown in FIG. 2 as a shaded box in frequency bins 216 of the range FFTs 214. The peak 218 corresponds to the distance of the object in range 122 from the receiver 110 (the first, second, third, or fourth receiver 110a, 110b, 110c, or 110d) that received the FMCW signal 206 being analyzed. The range FFTs 214 with this peak 218 correspond to the intermediate frequency indicating the presence of the object in range 122.

Using differentiated phase shift vectors applied to the phase shifters 107 in slow time enables FMCW signals 100 transmitted by a number T transmitters 109, and received by a number R receivers 110, to be treated as TxR separate received signals 206. For each of the R receivers 110, the object in range 122 will appear as T different peaks 218 in the range FFTs 214. This increases the spatial resolution of the FMCW radar system 100.

In step 220, the DSP 102 performs an FFT, in slow time, on the one-dimensional range FFTs 214. Accordingly, the DSP 102 performs an FFT on a temporally sequential set of the one-dimensional range FFTs 214, corresponding to one frame for one received signal 206, to produce a two-dimensional range-Doppler FFT 222. The range-Doppler FFT 222 includes a set of frequency bins 224 that each has (1) an index that represents a combination of range and velocity, and (2) a value indicating a return signal strength associated with the respective range and velocity. As described above, the range-Doppler FFT 222 covers a number of PRIs determined in response to a designed velocity resolution.

A vertical dimension of the range-Doppler FFT 222, corresponding to fast time, is divided into frequency bins 224 indicating range. The vertical dimension of the range-Doppler FFT 222 is also referred to as the range domain of the range-Doppler FFT 222. A horizontal dimension of the range-Doppler FFT 222, corresponding to slow time (across the selected number of PRIs), is divided into frequency bins 224 indicating Doppler shift. The horizontal dimension of the range-Doppler FFT 222 is also referred to as the Doppler domain of the range-Doppler FFT 222. In some examples, the selected number of PRIs covers a few tens of milliseconds.

A peak 226 (darkened box) in the range-Doppler FFT 222 indicates the presence of an object in range 122 having a given combination of range (e.g., distance from the FMCW radar system 100) and Doppler shift information (e.g., speed). A vertical coordinate of the particular frequency bin 224 in which the peak 226 is located indicates the range of the object in range 122 from the FMCW radar system 100. A horizontal coordinate of the particular frequency bin 224 in which the peak 226 is located provides Doppler shift information. The Doppler shift information represented by the peak 226 in the range-Doppler FFT 222 can be used to determine the speed of the object in range 122 relative to the FMCW radar system 100. In an example, the determined speed is an average speed over the selected number of PRIs used to generate the range-Doppler FFT 222.

FIG. 3 is a set of graphs illustrating an example process 300 for determining angle (angle of arrival) using range-Doppler FFTs 222. In some examples, range-Doppler FFTs 222 are generated by applying the process 200 of FIG. 2.

In the example illustrated in FIG. 1, the FMCW radar system 100 has three transmitters 109 and four receivers 110. As described above, this enables the process 200 to extract twelve distinct received signals 206 (referred to as virtual signals), which can also be viewed as twelve objects to be resolved. A disambiguation step, also referred to as transmitter decoding, is performed to distinguish the twelve objects, and then the corresponding range FFTs 214 are processed to generate twelve range-Doppler FFTs 222. Different distinguished objects correspond to different combinations of a transmitter 109 and a receiver 110, so that different range-Doppler FFTs 222 correspond to different transmitter-receiver combinations. The range-Doppler FFTs 222 are identified according to the transmitter 109 and the receiver 110 to which they correspond. As examples, a range-Doppler FFT 222 corresponding to the first transmitter (TX1) 109a and the third receiver (RX3) 110c is identified as TX1-RX3, and a range-Doppler FFT 222 corresponding to the third transmitter (TX3) 109c and the second receiver (RX2) 110b is identified as TX3-RX2.

As described above, by using range-Doppler FFTs 222 corresponding to multiple different receivers 110, an angle of the object in range 122 with respect to an orientation of the FMCW radar system 100 can be determined. For example, two receivers 110 can be used to determine an angle in a single plane, which can be combined with a range to generate a two-dimensional location of the object in range 122. For example, two receivers 110 can be used to determine range and azimuth of the object in range 122. Similarly, three receivers 110 can be used to determine angles in multiple planes, which can be combined with the range to determine a three-dimensional location of the object in range 122. For example, three receivers 110 can be used to determine range, azimuth, and elevation of the object in range 122. An accuracy with which angle information of the object in range 122 is determined is limited by the number of antennas used to receive the reflected signals.

FIG. 4 is a flow diagram of an example process 400 for determining range, velocity, and angle of arrival using data samples generated by the receiver signal chain 106 of FIG. 1. In some examples, the process 400 can be described as a summary of the processes 200 and 300 of FIGS. 2 and 3.

In step 402, the receiver signal chain 106 receives an FMCW signal(s) 206 from the receivers 110, processes the FMCW signal(s) 206 to generate an IF signal(s) 210, and samples the IF signal(s) 210 to produce a set of real-valued data samples. The data samples may be stored in a memory 120 until an entire frame of data samples is obtained or flow may proceed to step 404 when only some of the chirps in the frame have been sampled and stored in the memory 120. In step 404, the DSP 102 performs a real FFT on the real-valued samples to generate range FFTs 214 as described with respect to step 212, which may then be stored in the memory 120. In step 406, the DSP 102 performs a complex FFT on complex-valued samples corresponding to the range FFTs 214 produced according to step 404 to generate range-Doppler FFTs 222, which may then be stored in the memory 120. In step 408, the DSP 102 performs a complex FFT on complex-valued samples corresponding to the range-Doppler FFTs 222 to generate angle FFTs, which may then be stored in the memory 120. In step 410, the DSP 102 determines object presence, range, velocity, and angle (such as angle of arrival) responsive to information extracted from the range FFTs 214, range-Doppler FFTs 222, and angle FFTs. Accordingly, a process for object detection using the FMCW radar system 100 applies both real FFT and complex FFT to a data stream generated by the FMCW radar system 100.

In an example, step 410 can be performed as follows. Range, Doppler, and angle data are extracted from one or more range FFTs 214, range-Doppler FFTs 222, and angle FFTs to form a radar cube. The radar cube has a range dimension determined by the range data, a Doppler (or velocity) dimension determined by the Doppler data, and one or two angle dimensions determined by the angle data. A detection process uses the radar cube to determine point locations in space, with associated velocity vectors, to form a point cloud. A clustering and tracking process uses the radar cube and the point cloud. The clustering and tracking process divides the point cloud into groups of points corresponding to different objects, and determines a position and a motion vector for each of the determined objects.

FIG. 5 is a functional block diagram of a first example system 500 for selectably determining a real FFT or a complex FFT. The system 500 includes a clock circuit 501 that provides a clock signal, a radix-2 (R2) serial pipeline delayed feedback (SDF) hardware accelerator 502, a combiner stage 504, and a control circuit 505. The R2SDF 502 is an example of a serial pipelined complex FFT engine. Other types of complex FFT engines, such as complex FFT engines implementing serial feed-forward (SFF), an R2 square approach, radix-3, or radix-4 can be used in the system 500. The clock circuit is connected to clock the R2SDF 502, the combiner stage 504, and the control circuit 505. The control circuit 505 is connected to control the R2SDF 502 and the combiner stage 504.

The R2SDF 502 includes a number P R2 butterfly stages 506, P minus one multipliers 508, and P minus one twiddle factor tables 510. Each of the R2 butterfly stages 506 includes an R2 butterfly unit 512 numbered q, where q equals 1 to P, and a first-in-first-out (FIFO) memory 514 (sequentially labeled 514a, 514b, . . . , 514 (P−1), 514P) of varying depth. A R2 butterfly unit 512 furthest from the combiner stage 504 is numbered 1, and a R2 butterfly unit 512 nearest the combiner stage 504 is numbered P (as illustrated, from left to right). Accordingly, the R2 butterfly units 512 are numbered, and the FIFO memories 514 are labeled, in increasing order from left to right. The FIFO memory 514 corresponding to the first R2 butterfly unit 512 is a first FIFO memory 514a, sequentially followed by a second FIFO memory 514b, etc., up to a P^{th} FIFO memory 514P.

Twiddle factor tables 510 are similarly labeled, from left to right, 510a, 510b, . . . , 510 (P−1). The combiner stage 504 includes a conjugate symmetric combiner 516 and a ping-pong buffer 518. In some examples, a ping-pong buffer 518 is implemented as a pair of variable length memories, such as random access memories (RAM), with corresponding control circuits. In some examples, a different type of memory is used for the ping-pong buffer 518. The conjugate symmetric combiner 516 is so called because it uses a conjugate symmetry property of FFT, and combines pairs of samples produced by a complex FFT engine to produce real FFT result samples.

In some examples, an integer N used to specify a depth of the FIFO memories 514 represents a number of data samples that corresponds to the length of a PRI to generate a range FFT 214, or to the length of a frame to generate a range-Doppler FFT 222. N equals 2^{P}. The R2SDF 502 enables determination of an N-point complex discrete Fourier transform (DFT), accordingly, a DFT using complex-valued inputs. A DFT is a spectral domain (such as frequency domain) representation of a discrete-time sequence x(n), where n equals 0, 1, 2, . . . , N−1. The discrete-time sequence x(n) is, for example, a sequence of samples of an IF signal 210. In some examples, x(n) is a complex-valued number, and can be represented as shown in Equation 1, where j equals \sqrt{−1}, and a and b are real numbers:

$$x ( n ) = a + jb \qquad Equation 1$$

In some examples, N real-valued samples form N/2 complex-valued input samples to the R2SDF 502 (or other FFT engine). For example, referring to Equation 1, N/2 real-valued samples corresponding to a and N/2 real-valued samples corresponding to b are combined to form N/2 complex-valued samples corresponding to x(n). The N-point complex discrete Fourier transform (DFT) for a finite duration sequence x(n) is defined as shown in Equation 2, in which X(k) represents the output samples of the DFT:

$$X ( k ) = {\sum }_{n = 0}^{N - 1} x ( n ) {W}_{N}^{kn} , k = 0 , 1 , … , N - 1 \qquad Equation 2$$

The term W_{N}^{kn} in Equation 2 is the twiddle factor, which is provided by a corresponding twiddle factor table 510. The twiddle factor is defined as shown in Equation 3:

$${W}_{N}^{kn} = {e}^{- j ( 2 π / N ) kn} \qquad Equation 3$$

The definition of FFT is the same as DFT, but the method of computation differs. In some examples, an FFT corresponds to a divide-and-conquer approach to determining an N-point DFT by dividing the N-point DFT into successively fewer-point DFTs. In some examples, successive R2 butterfly stages 506, with corresponding multipliers 508 and twiddle factor tables 510, enable computation of such successively smaller DFTs to implement a complex FFT.

The FIFO memory corresponding to an R2 butterfly unit 512 numbered q includes sufficient memory to store 2^{P-q} samples, so that the FIFO memory 514a for the first R2 butterfly unit 512 can store N/2 samples, the FIFO memory 514b for the second R2 butterfly unit 512 can store N/4 samples, and the FIFO memory 514P for the P^{th} R2 butterfly unit 512 can store one sample.

A first input of the first R2 butterfly unit 512a (corresponding to the R2 butterfly unit 512 numbered 1) receives the discrete-time sequence x(n). Accordingly, as shown in Equation 1, the input of the first R2 butterfly unit 512, and each input and output in the subsequent data path, corresponds to a first input or output for a real-valued number (a) and a second input or output for an imaginary-valued number (jb).

In some examples, the system 500 is used to determine a DFT for a number of samples 2^{S}, where S is smaller than P so that 2^{S} is smaller than N. In such examples, the samples can be provided to the first input of the (P−S+1)^{th} R2 butterfly unit 512. In some examples, the system 500 can receive the discrete-time sequence x(n) from the ADC(s) 118 or the memory 120, or from another data sample source.

A first output of each R2 butterfly unit 512 other than the last (P^{th}) R2 butterfly unit 512 (corresponding to the R2 butterfly unit 512 numbered P) is connected to a first input of a corresponding multiplier 508. A second input of each multiplier 508 is connected to an output of a corresponding twiddle factor table 510. A first input of each R2 butterfly unit 512 other than the first R2 butterfly unit 512 is connected to an output of a corresponding multiplier 508, so that there is a multiplier 508 fed by a twiddle factor table 510 connected between each adjacent pair of R2 butterfly units 512 (some R2-based FFT implementations use fewer twiddle factor tables 510). A first output of the P^{th} R2 butterfly unit 512 is connected to a first input of the conjugate symmetric combiner 516, and also provides a complex FFT output X_{C}(n) of the system 500.

A second output of each R2 butterfly unit 512 is connected to an input of the corresponding FIFO memory 514. A second input of each R2 butterfly unit 512 is connected to an output of the corresponding FIFO memory 514. A second output of the conjugate symmetric combiner 516 is connected to an input of the ping-pong buffer 518. A second input of the conjugate symmetric combiner 516 is connected to an output of the ping-pong buffer 518. A first output of the conjugate symmetric combiner 516 provides a real FFT output X_{R}(n) of the system 500. Accordingly, the system 500 can be used to selectably provide a real FFT or a complex FFT responsive to a finite length input stream of samples x(n).

In some examples, the R2SDF 502 enables production of an output sample X_{C}(n) per cycle of the clock signal in response to an input sample x(n) per cycle, assuming a portion of the R2SDF 502 pipeline corresponding to the number of samples being processed(S) is full. In some examples, the combiner stage 504 enables production of an output sample X_{R}(n) per cycle in response to an input sample X_{C}(n) per cycle, assuming a corresponding pipeline is full.

Note that, as illustrated, the first input of each R2 butterfly unit 512 is a lower input and the second input of each R2 butterfly unit 512 is an upper input.

In an example, each R2 butterfly unit 512 operates either in a bypass mode or in an add/subtract mode. In the bypass mode, arithmetic functionality of that butterfly unit 512 is bypassed. Specifically, the first (lower) input of each respective R2 butterfly unit 512 is provided to the second (upper) output of the R2 butterfly unit, and the second (upper) input of the R2 butterfly unit 512 is provided to the first (lower) output of the R2 butterfly unit 512. In the add/subtract mode, the first and second inputs of the R2 butterfly unit 512 are added to generate a sum, and the second input is subtracted from the first input to generate a difference. The sum is provided to the first output of the R2 butterfly unit 512, and the difference is provided to the second output of the R2 butterfly unit.

In an example, P is five, so that there are five stages and 32 samples. The control circuit 505 controls each of the R2 butterfly units 512 to operate in either add/subtract mode or bypass mode.

During the first 16 cycles (cycles 0 through 15), R2 butterfly unit 1 512 is operated in bypass mode, so that the first FIFO memory 514a is filled with one sample per cycle, totaling the first 16 samples, such as x(0) through x(15). During the second 16 cycles, R2 butterfly unit 1 512 is operated in add/subtract mode. Accordingly, in cycle 17, x(16)+x(0) is provided to the first output (to the multiplier 508) and x(16)−x(0) is provided to the second output (to the first FIFO memory 514a). In cycle 18, x(17)+x(1) is provided to the first output (to the multiplier 508) and x(17)−x(1) is provided to the second output (to the first FIFO memory 514a), etc. During the third 16 cycles, R2 butterfly unit 1 512 is again operated in bypass mode, so that the differences loaded into the first FIFO memory 514a during the second 16 cycles are fed to the multiplier 508, and a new set of 16 samples is loaded into the first FIFO memory 514a.

The twiddle factor tables 510 include twiddle factors stored in memory, such as read-only memory (ROM). The first twiddle factor table 510a, which follows (is connected to the first output of) the first R2 butterfly unit 512, includes 32 elements (2^{P} elements) to respectively be applied to the 16 sums (2^{P-1} sums) and 16 differences (2^{P-1} differences) provided by R2 butterfly unit 1 512 during each calculation period of R2 butterfly unit 1 512. As described above, each calculation period of R2 butterfly unit 1 512 includes 16 cycles (2^{P-1} cycles) in add/subtract mode and a subsequent 16 cycles (2^{P-1} cycles) in bypass mode.

A calculation period for R2 butterfly unit 2 512 is half as long as the calculation period for R2 butterfly unit 1 512. Accordingly, the second twiddle factor table 510b, which corresponds to the second R2 butterfly unit 512, includes 16 elements (2^{P-1} elements) to respectively be applied to the 8 sums (2^{P-2} sums) and 8 differences (2^{P-2} differences) provided by the R2 butterfly unit 2 512 during each calculation period of R2 butterfly unit 2 512. Each calculation period of R2 butterfly unit 2 512 includes 8 cycles (2^{P-2} cycles) in add/subtract mode and a subsequent 8 cycles (2^{P-2} cycles) in bypass mode.

Subsequent R2 butterfly units 512 sequentially halve the number of cycles in a calculation period of the sequentially previous R2 butterfly unit 512, with half the number of sums and half the number of differences provided to the corresponding multiplier 508. Similarly, subsequent twiddle factor tables 510 store half the number of twiddle factors as the sequentially previous twiddle factor table 510.

Addressing logic of the control circuit 505 determines which twiddle factor is to be applied to an output of a corresponding R2 butterfly unit 512. If the R2 butterfly unit 512 is operated in add/subtract mode, the outputs of the R2 butterfly unit 512 provided to the corresponding multiplier 508 are sums, and the corresponding twiddle factor table 510 provides twiddle factors equal to one. Accordingly, sums effectively bypass the corresponding multiplier 508 (i.e., multiply by one). If the R2 butterfly unit 512 is operated in bypass mode, the output of the R2 butterfly unit 512 corresponds to differences (subtracted values), and the corresponding twiddle factor table 510 provides twiddle factors equal to complex numbers. The multiplier 508 multiplies these complex numbers by the corresponding differences. In some examples, the addressing logic retrieves the twiddle factors from the twiddle factor tables 510 in a sequential order per cycle, returning to a first stored twiddle factor in a twiddle factor table 510 after a calculation cycle of the corresponding R2 butterfly unit 512 has passed.

The conjugate symmetric combiner 516 determines a real FFT responsive to output of a complex FFT engine such as an R2SDF 502. Recall that an R2 butterfly unit 512 other than the first R2 butterfly unit 512 (R2 butterfly unit 1 512) can receive the input data if the number of samples S being processed for a single FFT is less than the number of samples N the system 500 can process for a single FFT. To determine a real FFT, an R2 butterfly unit 512 receiving the input data is provided two real-valued data samples in each cycle. One of the two real-valued data samples is provided as a real number, and the other of the two real-valued data samples is provided as an imaginary number before being provided to the first R2 butterfly unit 512. Accordingly, the other of the two real-valued data samples is multiplied by \sqrt{−1} before being provided to the first R2 butterfly unit 512. Output samples of the R2SDF 502 responsive to complex-valued inputs corresponding to real-valued samples are referred to as G(k).

Two example approaches to determining a real FFT responsive to G(k) output samples provided by a complex FFT engine are described below, though additional approaches are also available. An example conjugate symmetric combiner 516 implementing the first example approach is described with respect to FIG. 8.

A first example approach uses a single stream x(n) of real-valued samples, such as samples originating from a single IF signal 210 corresponding to a single received signal 206. A complex-valued sample stream g(n) is provided as input to the R2SDF 502 responsive to even number-indexed samples xₑ(n) and odd number-indexed samples (xₒ(n)) of the real-valued sample stream x(n). For n from 0 to N−1, xₑ(n) corresponds to x(0), x(2), . . . , x(N−2), and Xₒ(n) corresponds to x(1), x(3), . . . , x(N−1). Accordingly, the N/2-point complex-valued sample stream g(n) is defined as shown in Equations 4 and 5, where i is an even integer index:

$$g ( n ) = {x}_{o} ( n ) + {jx}_{e} ( n ) , n = 0 , 1 , … , N / 2 - 1 \qquad Equation 4$$

$$g ( n ) = x ( i ) + jx ( i + 1 ) , i = 0 , 2 , 4 , … , N - 2 \qquad Equation 5$$

The input stream g(n) causes the R2SDF 502 to responsively determine an N-point stream of complex-valued output samples G(k) (input samples of the conjugate symmetric combiner 516), as described above. The output of the real FFT is X(k), which is derived from the various G(k) as described below with respect to Equations 7 through 10. Equation 6 defines G(k) in terms of Xₒ(k) and Xₑ(k), which are complex-valued intermediate values. Xₒ(k) corresponds to the FFT of Xₒ(k), and Xₑ(k) corresponds to the FFT of Xₑ(k). Note that both Xₒ(k) and Xₑ(k) are not available as signals within the R2SDF 502 or as output from the R2SDF 502 (or other FFT engine). As described above, G(k) is shown in Equation 6:

$$G ( k ) = {X}_{o} ( k ) + {jX}_{e} ( k ) , k = 0 , 1 , … , \frac{N}{2} - 1 \qquad Equation 6$$

Herein a star operator (*) is used to indicate a complex conjugate. The complex conjugate of a +jb is a −jb. G(k) is defined with respect to the range [0, . . . , N/2−1] because the DFT of a real-valued sequence has the properties of complex conjugate symmetry and periodicity. Accordingly, Xₒ(k) and Xₑ(k) are determined as shown in Equations 7 and 8, respectively:

$${X}_{o} ( k ) = \frac{1}{2} [ G ( k ) + {G}^{*} ( \frac{N}{2} - k ) ] , k = 0 , 1 , … , \frac{N}{4} \qquad Equation 7$$

$${X}_{e} ( k ) = \frac{1}{2 j} [ G ( k ) - {G}^{*} ( \frac{N}{2} - k ) ] , k = 0 , 1 , … , \frac{N}{4} \qquad Equation 8$$

Xₒ(k) and Xₑ(k) are used to determine output samples X(k) and X(N/2−k) as shown in Equations 9 and 10, respectively:

$$X ( k ) = {X}_{e} ( k ) + {X}_{o} ( k ) {W}_{N}^{k} , k = 0 , 1 , … , \frac{N}{4} \qquad Equation 9$$

$$X ( \frac{N}{2} - k ) = {X}_{e}^{*} ( k ) - {X}_{o}^{*} ( k ) {W}_{N}^{k} , k = 0 , 1 , … , \frac{N}{4} \qquad Equation 10$$

Equations 7 and 8 receive as inputs G(k) and G*(N/2−k). Accordingly, determining two output samples X(k) and X(N/2−k) is responsive to two input samples, except for special cases X(0) and X(N/4). From Equations 7 and 8, if k=0 then Xₒ(k) equals G(k) and Xₑ(k) equals zero, because G(0) equals G*(N/2) according to the conjugate symmetric property. Also, if k=N/4, then N/2−k=N/4. Accordingly, the first approach to determining a real FFT responsive to output of the R2SDF 502 provides N/2 complex-valued output samples X(k) in response to N real-valued input samples x(n) received by the R2SDF 502.

A second example approach to determining a real FFT responsive to G(k) uses two streams of real-valued samples, a first stream x₁(n) and a second stream x₂(n). In some examples, x₁(n) is a stream of samples of a first IF signal 210 and x₂(n) is a stream of samples of a second IF signal 210. Accordingly, the complex-valued samples g(n) provided as input to the R2SDF 502 include samples from the first stream x₁(n) provided as real values, and samples from the second stream x₂(n) provided as complex values, accordingly, multiplied by j. Equation 11 shows g(n) determined using two streams of N real-valued samples each:

$$g ( n ) = {x}_{1} ( n ) + {jx}_{2} ( n ) , n = 0 , 1 , … , N - 1 \qquad Equation 11$$

The R2SDF 502 provides complex-valued output samples G(k) responsive to the combined input samples g(n). G(k) can be expressed as a sum of FFT output samples X₁(k) responsive to the real-valued sample stream X₁(n), plus FFT output samples X₂(k) responsive to the real-valued sample stream x₂(n). Each sample X₂(k) is multiplied by j to enable it to be processed as an imaginary component of G(k). This relationship is shown in Equation 12:

$$G ( k ) = {X}_{1} ( k ) + {jX}_{2} ( k ) , k = 0 , 1 , … , N - 1 \qquad Equation 12$$

As described above, the DFT of a real-valued sequence has the properties of complex conjugate symmetry and periodicity. Accordingly, X₁(k) and X₂(k) are determined as shown in Equations 13 and 14, respectively:

$${X}_{1} ( k ) = \frac{1}{2} [ G ( k ) + {G}^{*} ( N - k ) ] , k = 0 , 1 , … , \frac{N}{2} \qquad Equation 13$$

$${X}_{2} ( k ) = \frac{1}{2 j} [ G ( k ) - {G}^{*} ( N - k ) ] , k = 0 , 1 , … , \frac{N}{2} \qquad Equation 14$$

Accordingly, the DFT of x₁(n) is represented by the output samples X₁(k), and the DFT of x₂(n) is represented by the output samples X₂(k).

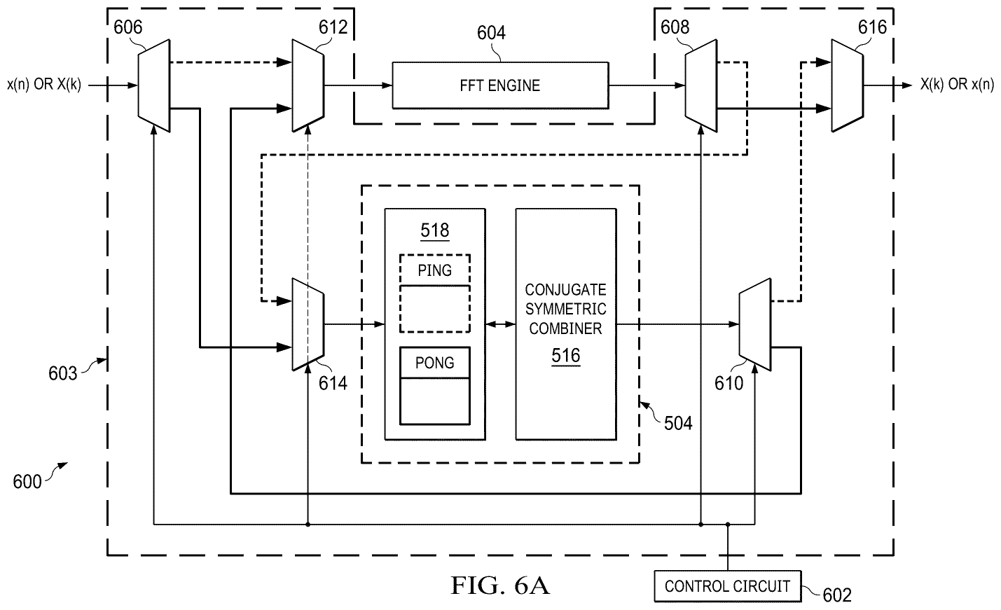

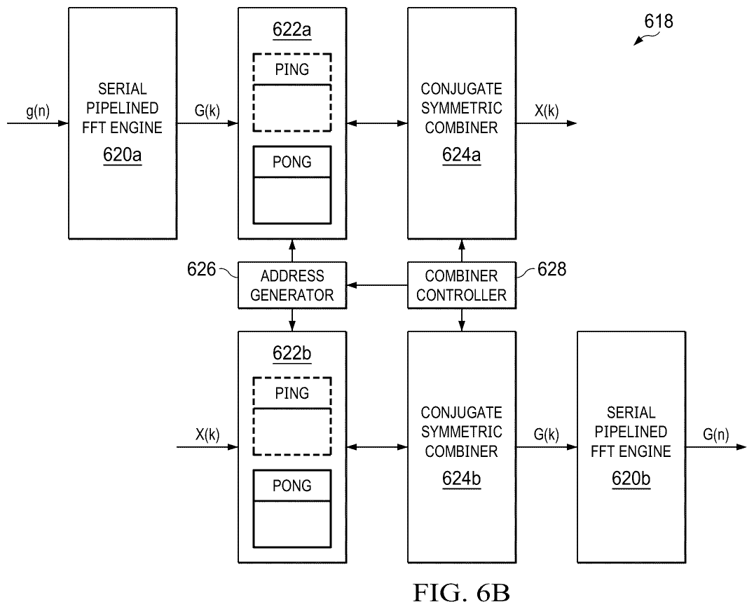

Systems for selectably determining a real FFT or a real IFFT are further discussed with respect to FIGS. 6A and 6B. Systems for selectably determining a real FFT, a real IFFT, a complex FFT, or a complex IFFT are discussed with respect to FIGS. 7, 10, and 14. The conjugate symmetric combiner 516 is further discussed with respect to FIG. 8. Processes for performing a real FFT or real IFFT, corresponding to operation of the conjugate symmetric combiner 516 with the ping-pong buffer 518, are further discussed with respect to FIGS. 9, 11A through 13, and 15 through 22.

FIG. 6A is a functional block diagram of a second example system 600 for selectably determining a real FFT or a real inverse FFT. The system 600 includes a control circuit 602, a real FFT/IFFT processing block 603, and an FFT engine 604 that generates complex FFT output samples (X(k) in Equation 2 or G(k) in Equation 6 or 12). Complex FFT output samples provided by the FFT engine 604 are treated as input samples (G(k) in Equations 6 through 8 and 12 through 14) by the conjugate symmetric combiner 516 for the purpose of determining a real FFT. In some examples, operation of the FFT engine 604 is the same when computing a real FFT, a real inverse FFT, a complex FFT, or a complex inverse FFT.

The real FFT/IFFT processing block 603 includes a first demultiplexer 606, a second demultiplexer 608, a third demultiplexer 610, a first multiplexer 612, a second multiplexer 614, a third multiplexer 616, and a combiner stage 504. As described above, the combiner stage 504 includes a conjugate symmetric combiner 516 and a ping-pong buffer 518. In some examples, the FFT engine 604 is an R2SDF 502 (FIG. 5) or a different type of FFT engine, such as a different type of serial pipelined FFT engine. In some examples, as described with respect to FIG. 5, the system 600 can also be used to selectably determine a complex FFT or a complex IFFT.

First outputs of demultiplexers 606, 608, and 610 and first inputs of multiplexers 612, 614, and 616 correspond to a real FFT data path of the system 600. Second outputs of demultiplexers 606, 608, and 610 and second inputs of multiplexers 612, 614, and 616 correspond to a real IFFT data path of the system 600. Also, the real FFT data path is indicated by a dotted line, and the IFFT data path is indicated by a solid line. An output of the control circuit 602 is connected to control inputs of the each of the demultiplexers 606, 608, and 610 and each of the multiplexers 612, 614, and 616. Control signals are provided by the control circuit 602 to the demultiplexers 606, 608, and 610 and the multiplexers 612, 614, and 616 to select between the real FFT data path and the real IFFT data path. In particular, the demultiplexers 606, 608, and 610 and the multiplexers 612, 614, and 616 operate to couple the combiner stage 504 either after the FFT engine 604 for a real FFT or before the FFT engine 604 for a real IFFT.

To perform a real FFT, an input of the first demultiplexer 606 receives a signal stream x(n). To perform a real IFFT, an input of the first demultiplexer 606 receives a signal stream X(k) (Equation 15, below). A first (upper) output of the first demultiplexer 606 is connected to a first (upper) input of the first multiplexer 612. A second (lower) output of the first demultiplexer 606 is connected to a second (lower) input of the second multiplexer 614. An output of the first multiplexer 612 is connected to an input of the FFT engine 604. An output of the FFT engine 604 is connected to an input of the second demultiplexer 608. A first (upper) output of the second demultiplexer 608 is connected to a first (upper) input of the second multiplexer 614. A second (lower) output of the second demultiplexer 608 is connected to a second (lower) input of the third multiplexer 616.

An output of the second multiplexer 614 is connected to an input of the ping-pong buffer 518. The ping-pong buffer 518 and the conjugate symmetric combiner 516 are connected to communicate with each other. An output of the conjugate symmetric combiner 516 is connected to an input of the third demultiplexer 610. A first (upper) output of the third demultiplexer 610 is connected to a first (upper) input of the third multiplexer 616. A second (lower) output of the third demultiplexer 610 is connected to a second (lower) input of the first multiplexer 612.

An IFFT estimates input samples x(n) responsive to FFT output samples X(k). Accordingly, an IFFT determines x(n) as shown in Equation 15:

$$x ( n ) = \frac{1}{N} {\sum }_{k = 0}^{N - 1} X ( k ) {W}_{N}^{- kn} , n = 0 , 1 , … , N - 1 \qquad Equation 15$$

In some examples where N is a power of two, division by N is implemented using a bit shift of an exponent or mantissa of a numerical representation of a corresponding sample value. Equations describing determination of a real-valued IFFT using the FFT engine 604 and the conjugate symmetric combiner 516 are similar to those describe determination of a real-valued FFT. In some examples, equations describing determination of a real-valued IFFT can be derived using Equations 2 through 10 and 15.

The real FFT data path (dotted line) passes first through the FFT engine 604, then the ping-pong buffer 518, then the conjugate symmetric combiner 516, and the combiner stage 504 provides real FFT output samples for the system 600. The real IFFT data path (solid line) passes first through the ping-pong buffer 518, then the conjugate symmetric combiner 516. The combiner stage 504 provides intermediate samples to the FFT engine 604, and the FFT engine 604 provides IFFT output samples for the system 600.

In some examples, use of a combiner stage 504 with an FFT engine 604 enables selectable determination of a real FFT, a real IFFT, a complex FFT, or a complex IFFT. In some examples, use of a combiner stage 504 with an FFT engine 604 enables these selectable determinations to be performed so that one complex-valued output sample is provided per clock cycle responsive to one real-valued or complex-valued input sample provided per clock cycle. In some examples, a conjugate symmetric combiner 516 implementing the first approach to determining a real FFT, as described with respect to Equations 4 through 10, enables reduced memory usage when determining a real FFT. In some examples, memory usage is reduced in both the R2SDF 502 and in the conjugate symmetric combiner 516 due to a reduced number of input samples x(n) to the R2SDF 502 and a reduced number of input samples G(k) to the conjugate symmetric combiner 516.

In some examples, this enables benefits such as reduced memory and computational hardware requirements in a hardware accelerator for real-valued and complex-valued FFT and IFFT computation, generation of FFT outputs for complex-valued input signals as well as real-valued input signals, generation of IFFT outputs for complex-valued output signals as well as real-valued output signals, twice the FFT throughput for real-valued input signals with respect to complex-valued input signals, and twice the IFFT throughput for real-valued output signals with respect to complex-valued output signals.

FIG. 6B is a functional block diagram of a third example system 618 for selectably determining a real FFT or a real IFFT. The system 618 includes a first serial pipelined FFT engine 620a such as an R2SDF 502, a first ping-pong buffer 622a, a first conjugate symmetric combiner 624a, a second serial pipelined FFT engine 620b, a second ping-pong buffer 622b, a second conjugate symmetric combiner 624b, an address generator 626, and a combiner controller 628.

An input of the first serial pipelined FFT engine 620a receives a real input sample stream g(n) (see, for example, Equations 4 and 5). An output of the first serial pipelined FFT engine 620a provides a complex intermediate sample stream G(k) (see, for example, Equation 6) to an input of the first ping-pong buffer 622a. The first ping-pong buffer 622a is communicatively connected to the first conjugate symmetric combiner 624a. The first conjugate symmetric combiner 624a provides real FFT output samples X(k) (see, for example, Equations 7 to 10). In an example, a data path from the input of the first serial pipelined FFT engine 620a through the first ping-pong buffer 622a and the first conjugate symmetric combiner 624a corresponds to the real FFT data path described with respect to FIG. 6A.

An input of the second ping-pong buffer 622b receives real FFT output samples X(k). The second ping-pong buffer 622b is communicatively connected with the second conjugate symmetric combiner 624b. The second conjugate symmetric combiner 624b provides a complex intermediate IFFT sample stream G(k) to an input of the second serial pipelined FFT engine 620b. The second serial pipelined FFT engine 620b provides real IFFT output samples g(n). In an example, a data path from the input of the second ping-pong buffer 622b through the second conjugate symmetric combiner 624b and the second serial pipelined FFT engine 620b corresponds to the real IFFT data path described with respect to FIG. 6A.

A first output of the combiner controller 628 is connected to a control input of the first conjugate symmetric combiner 624a. A second output of the combiner controller 628 is connected to a control input of the second conjugate symmetric combiner 624b. A third output of the combiner controller 628 is connected to the address generator 626. A first output of the address generator 626 is connected to the first ping-pong buffer 622a. A second output of the address generator 626 is connected to the second ping-pong buffer 622b.

FIG. 7 is a functional block diagram of an example system 700 for selectably determining a real FFT, a real IFFT, a complex FFT, or a complex IFFT. The system 700 includes a first multiplexer 702, a second multiplexer 704, a demultiplexer 706, a control circuit 708, and the system 600 of FIG. 6A. As described above, the system 600 includes an FFT engine 604 and a real FFT/IFFT processing block 603. The first multiplexer 702 is connected to a first input terminal 710 that receives complex-value samples and to a second input terminal 712 that receives real-value samples.

In some examples, complex-value samples correspond to an input stream x(n) to a complex FFT or an input stream X(k) to a complex IFFT. In some examples, real samples correspond to an input stream g(n) to a real FFT or an input stream X(k) to a real IFFT. In some examples, the control circuit 708 includes one or more of the clock circuit 501 and/or the control circuit 505 of FIG. 5, or the control circuit 602 of FIG. 6A, or the combiner controller 628 and/or the address generator 626 of FIG. 6B.

FIG. 8 is a functional block diagram of an example implementation 800 of the conjugate symmetric combiner 516 or 624 of FIGS. 5, 6A, and 6B. The illustrated implementation 800 of the conjugate symmetric combiner 516 includes a first stage 802, corresponding to Equations 7 and 8, and a second stage 804, corresponding to Equations 9 and 10. The first stage 802 includes a first adder 805, a second adder 806, a first negation block 808 (which multiplies an input by negative one), a first conjugate block 810 (which provides a complex conjugate of its input), and a negative j block 812 (which multiplies its input by negative \sqrt{−1}, corresponding to the 1/j factor in Equation 14). The second stage 804 includes a multiplier 814, a twiddle memory 816 (a twiddle factor table), a third adder 818, a fourth adder 820, a second negation block 822, a second conjugate block 824, and a third conjugate block 826. In some examples, the twiddle memory 816 is a ROM. Note that scaling factors, such as the ½ factor in Equations 7 and 8, can be implemented using (for example) bit shifts, or may be addressed in other ways. In some examples, the ½ factor in Equations 7 and 8 corresponds to a shift of bit to the right in a little endian numerical format. In some examples, the ½ factor in Equations 7 and 8 is communicated to a user for interpretation of the output, without explicit inclusion in computation.

In some examples, a real component of a sample is determined using a first data path corresponding to the sample and an imaginary component of the sample is determined using a second data path corresponding to the sample. In some examples, the negative j block 812 swaps the real and imaginary components of a sample and negates (multiplies by negative one) the imaginary component.

In the first stage 802, a first input terminal 828 receives G(k) (or X(k)), and a second input terminal 830 receives G(N/2−k) (or X(N/2−k)). The first input terminal 828 provides G(k) to a first input of the first adder 805 and to an input of the first negation block 808. An output of the first negation block 808 is connected to a first input of the second adder 806. The second input terminal 829 provides G(N/2−k) to an input of the first conjugate block 810. An output of the first conjugate block 810 is connected to a second input of the first adder 805 and to a second input of the second adder 806. An output of the second adder 806 is connected to an input of the negative j block 812. An output of the first adder 805 provides a first output Xₒ(k) of the first stage 802 (Equation 7), and an output of the negative j block 812 provides a second output Xₑ(k) of the first stage 805 (Equation 8).

The output of the first adder 805 is connected to a first input of the multiplier 814. A second input of the multiplier 814 is connected to an output of the twiddle memory 816. An output of the multiplier 814 is connected to a first input of the third adder 818 and an input of the second conjugation block 824. An output of the second conjugation block 824 is connected to an input of the second negation block 822. An output of the second negation block 822 is connected to a first input of the fourth adder 820. An output of the negative j block 812 is connected to a second input of the third adder 818 and an input of the third conjugation block 826. An output of the third conjugation block 826 is connected to a second input of the fourth adder 820. An output of the third adder 818 provides a first output X(k) of the second stage 804 (Equation 9), and an output of the fourth adder 820 provides a second output X(N/2−k) of the second stage 804 (Equation 10). First and second outputs of the second stage 804 correspond to first and second outputs of the conjugate symmetric combiner 516.

FIG. 9 is a set of input samples 900 provided by the FFT engine 604 of FIG. 6A to be processed by the conjugate symmetric combiner 516 of FIGS. 5 and 6A to determine an FFT of the input samples 900 using a radix-2 approach. Accordingly, the FFT engine 604 uses a radix-2 approach to determine a complex FFT, and is, for example, an R2SDF 502.

In some examples, such as examples corresponding to an R2SDF 502, the FFT engine 604 provides input samples (G(k)) 900 that are bit-reversed with respect to input samples. Bit-reversal refers to a specific ordering of the input samples. In an example, input samples x(n) are little endian, so that a highest index bit (typically written on the left of a visual expression of a binary number) is a most significant bit (MSB) and a lowest index bit is a least significant bit (LSB). Accordingly, bit-reversed input samples 900 are big endian, so that a highest index bit is the LSB and the lowest index bit is the MSB. Alternatively, bit-reversal changes an ordering of bits within a sample. For example, bit-reversing 100 produces 001.

In some examples, the index k is also bit-reversed and the N/2 input samples 900 are provided in an order that is sequential from k equals zero to k equals N/2. For example, for N equals 32, a binary count from zero to N/2−1 is 0000 (0), 0001 (1), 0010 (2), 0011 (3), 0100 (4), 0101 (5), 0110 (6), 0111 (7), 1000 (8), 1001 (9), 1010 (10), 1011 (11), 1100 (12), 1101 (13), 1110 (14), and 1111 (15). Bit-reversed, this count is, sequentially, 0000 (0), 1000 (8), 0100 (4), 1100 (12), 0010 (2), 1010 (10), 0110 (6), 1110 (14), 0001 (1), 1001 (9), 0101 (5), 1101 (13), 0011 (3), 1011 (11), 0111 (7), and 1111 (15). Accordingly, in the example, the input samples 900 are provided in a bit-reversed index sequential order k=0, 8, 4, 12, 2, 10, 6, 14, 1, 9, 5, 13, 3, 11, 7, 15.

The input samples 900 are processed in four phases, corresponding to four quarters of the input samples. In an example, N equals 32. A first quarter 902 corresponds to k=0 to N/8-1, which is 0 to 3 in the example. A second quarter 904 corresponds to k=N/8 to N/4-1, which is 4 to 7 in the example. A third quarter 906 corresponds to k=N/4 to 3N/8-1, which is 8 to 11 in the example. A fourth quarter 908 corresponds to k=3N/8 to N/2−1, which is 12 to 15 in the example. Pairing lines 910 indicate which input samples 900 G(k) and G(N/2−k) are processed together by the conjugate symmetric combiner 516.

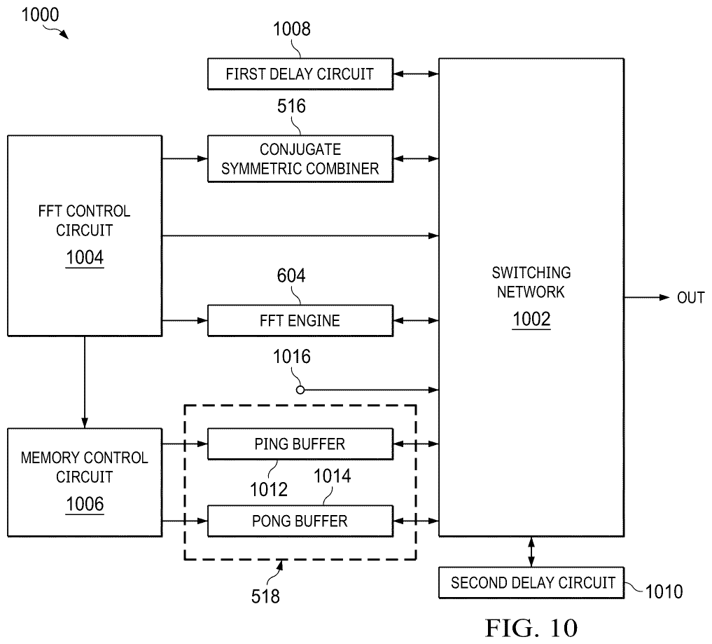

FIG. 10 is a functional block diagram of an example system 1000 for selectably determining a real FFT, a real IFFT, a complex FFT, or a complex IFFT. The system 1000 includes a switching network 1002, an FFT control circuit 1004, a memory control circuit 1006, a first delay circuit 1008, a second delay circuit 1010, an FFT engine 604, a conjugate symmetric combiner 516, and a ping-pong buffer 518. The ping-pong buffer 518 includes a ping buffer 1012 and a pong buffer 1014. In some examples, the ping buffer 1012 and the pong buffer 1014 are each memories, such as variable-length address ranges within a memory. In some examples, the ping buffer 1012 and the pong buffer 1014 are volatile memories, such as RAM. In some examples, the lengths of the ping buffer 1012 and the pong buffer 1014 depend on the number of input samples, such as input samples 900.

In some examples, the memory control circuit 1006 stores a memory address corresponding to a memory location of each of the ping buffer 1012 and the pong buffer 1014 (accordingly, two separate memory addresses). A value of an input sample 900 can be written to, or read and deleted from, the ping buffer 1012 or pong buffer 1014 at the respective memory address indicated by the memory control circuit 1006. The FFT control circuit 1004 adjusts the respective memory addresses in the memory control circuit 1006 for the ping buffer 1012 and/or pong buffer 1014 responsive to progress through a real FFT or real IFFT process being performed.

A first output of the FFT control circuit 1004 is connected to a control input of the switching network 1002, and a second output of the FFT control circuit 1004 is connected to a control input of the conjugate symmetric combiner 516. A third output of the FFT control circuit 1004 is connected to a control input of the FFT engine 604, and a fourth output of the FFT control circuit 1004 is connected to a control input of the memory control circuit 1006. In some examples, the memory control circuit 1006 includes the address generator 626 of FIG. 6B. A first output of the memory control circuit 1006 is connected to a control input of the ping buffer 1012, and a second output of the memory control circuit 1006 is connected to a control input of the pong buffer 1014.

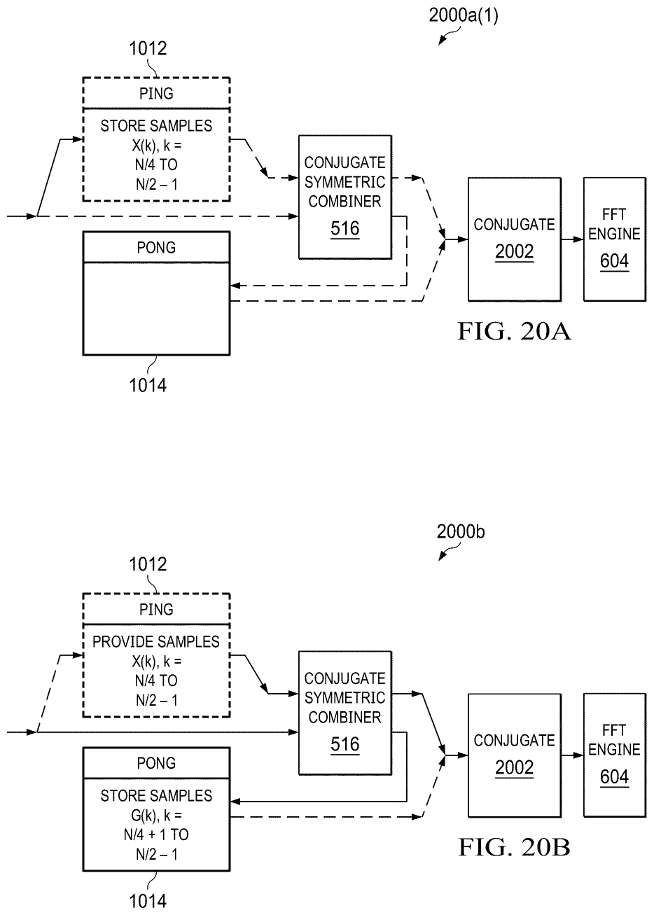

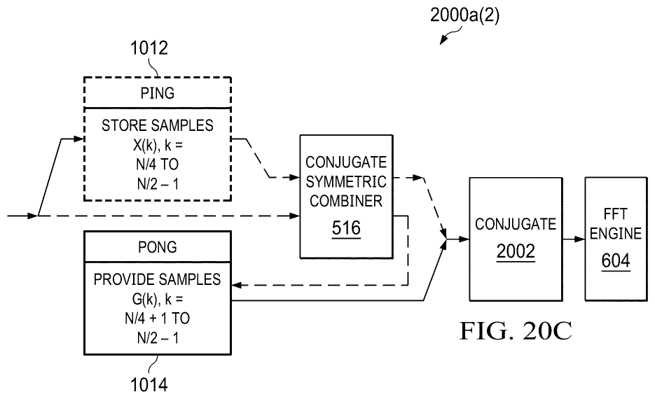

The conjugate symmetric combiner 516, the FFT engine 604, the first delay circuit 1008, the second delay circuit 1010, the ping buffer 1012, and the pong buffer 1014 are each communicatively connected to one or more data inputs of the switching network 1002. An input terminal 1016 is also connected to the (or a) data input of the switching network 1002. In some examples, the input terminal 1016 corresponds to an output of a memory, such as the memory 120 of FIG. 1. In some examples, additional components (such as the conjugate block 2002 described with respect to FIGS. 20A through 20C) are also included in the system 1000 and communicatively connected to the switching network 1002.

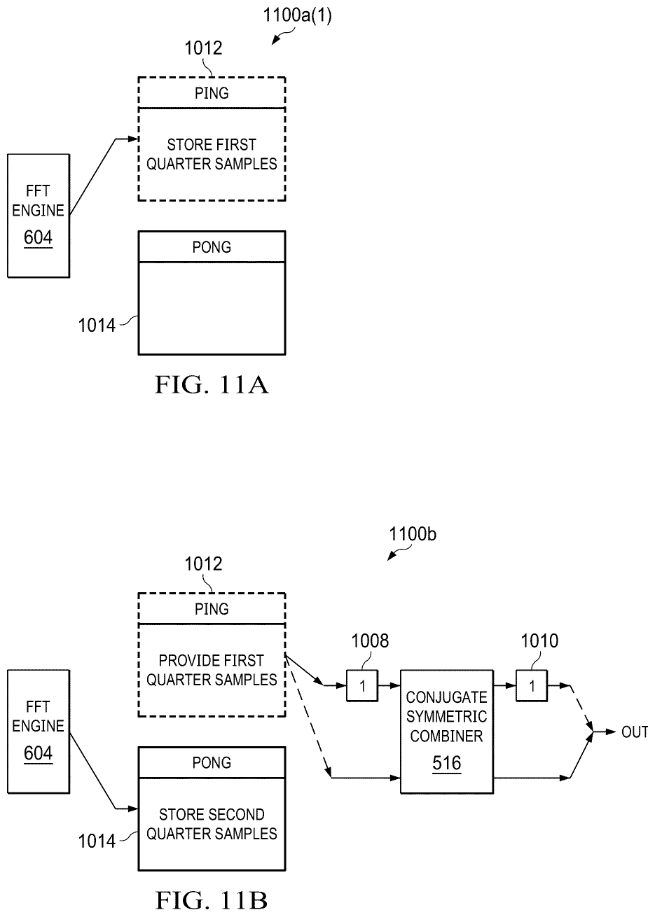

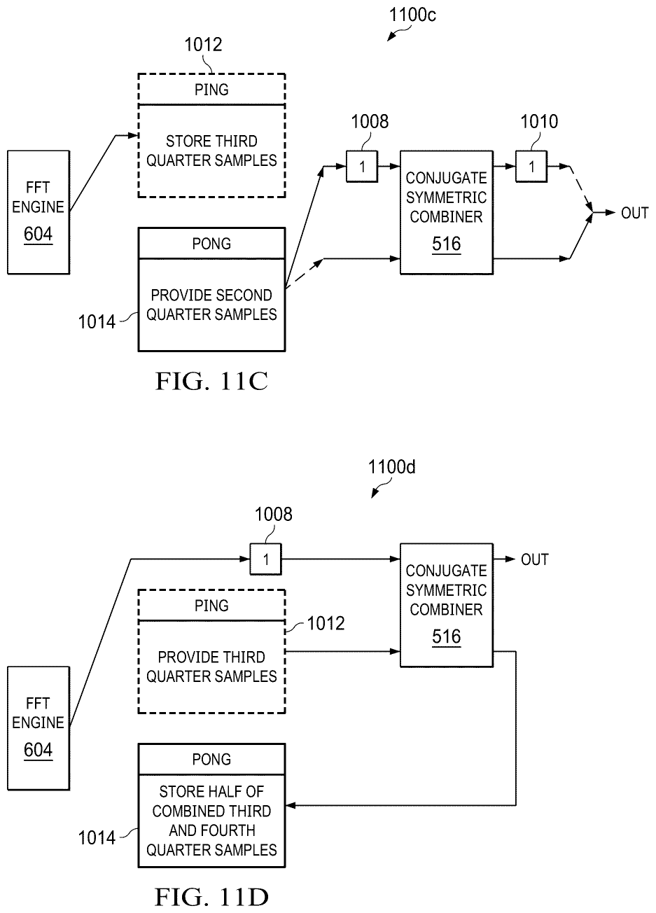

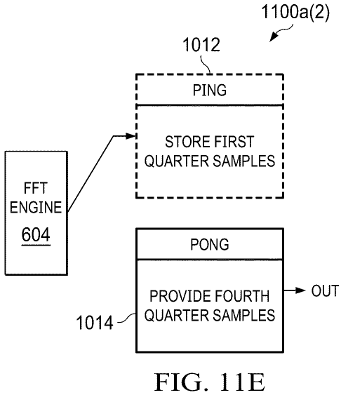

In some examples, the switching network 1002 includes one or more of switches, multiplexers, demultiplexers, or other data path selection components. The switching network 1002 provides an output of the system 1000 (output signal OUT), such as X(k) for an FFT or x(n) for an IFFT. In some examples, output of the system 1000 is converted (or formatted) into a specified number format and provided to memory, such as RAM. Various views of the system are described with respect to FIGS. 11A through 11E, 16A through 16D, and 20A through 20C. These various views are differentiated by different signal path routing selections determined by the switching network 1002 responsive to the FFT control circuit 1004.

FIG. 11A is a functional block diagram of a view of the system 1000 corresponding to a first phase 1100a (1) in a first iteration of an example radix-2 process 1100 for determining an N-point real FFT. The process 1100 uses an FFT engine 604 that determines complex FFT outputs using a radix-2 approach, such as an R2SDF 502.

As described above, each phase in the process 1100 corresponds to providing one quarter 902, 904, 906, or 908 of the input samples 900 to the conjugate symmetric combiner 516 and/or the ping-pong buffer 518. The first iteration of the process 1100 corresponds to performance of the process 1100 after the system 1000 is reset (accordingly, volatile memory, such as ping-pong buffers 518, is cleared), such as in response to device power on. The first phase 1100a (1) is handled differently for the first iteration of the process 1100 than in later iterations of the process 1100.

The view corresponding to the first phase 1100a (1) includes the FFT engine 604, the ping buffer 1012, and the pong buffer 1014. During the first phase 1100a (1) in the first iteration of a process 1100 for determining an N-point real FFT, the FFT engine 604 provides and the ping buffer 1012 stores the first N/8 input samples 900. In an example in which N equals 32, the FFT engine 604 outputs and the ping buffer 1012 stores G(0), G(8), G(4), and G(12) over the course of four cycles. Accordingly, in some examples, it takes one cycle to move each first quarter sample 902 from the output of the FFT engine 604 into the ping buffer 1012 to complete the first phase 1100a (1), corresponding to N/8=4 total cycles. The pong buffer 1014 remains empty during the first iteration of the first phase 1100a (1).

In some examples, each of the FFT engine 604, the ping buffer 1012, the pong buffer 1014, the first delay circuit 1008, the second delay circuit 1010, the conjugate symmetric combiner 516, and the input terminal 1016 can provide values on one of a rising edge or falling edge of the clock signal. In some examples, the ping buffer 1012, the pong buffer 1014, the first delay circuit 1008, and the second delay circuit 1010 can accept and/or store (as appropriate) the values on the other of the rising edge or falling edge of the clock signal. In some examples, the conjugate symmetric combiner 516 can receive a value on the other of the rising edge or falling edge of the clock signal, and takes a cycle to process received value(s).

FIG. 11B is a functional block diagram of a view of the system 1000 corresponding to a second phase 1100b of the example radix-2 process 1100 for determining an N-point real FFT. The second phase 1100b corresponds to the second quarter 904 of input samples 900. The view corresponding to the second phase 1100b includes the FFT engine 604, the ping buffer 1012, the pong buffer 1014, the first delay circuit 1008, the second delay circuit 1010, and the conjugate symmetric combiner 516. The two inputs of the conjugate symmetric combiner 516 described with respect to FIGS. 11A to 11E, 16A to 16D, and 20A to 20C correspond to samples Xₒ(k) and Xₑ(k) described with respect to Equations 6 through 10. Accordingly, two samples received by inputs of the conjugate symmetric combiner 516 during a cycle together correspond to G(k) as described with respect to Equation 6.

The FFT engine 604 provides the second quarter 904 of input samples 900 to the pong buffer 1014, which stores the received input samples 904. Concurrently, the ping buffer 1012 provides the first quarter 902 of input samples 900, alternatingly in sequence, to the first delay circuit 1008 and to a second input of the conjugate symmetric combiner 516. The first delay circuit 1008 outputs the received first quarter samples 902 to the first input of the conjugate symmetric combiner 516 after a delay, such as a one cycle delay, so that the conjugate symmetric combiner 516 contemporaneously receives a value at each of its first and second inputs.

In some examples, the pong buffer 1014 stores input samples 900 in bit-reversed index sequential order G(2), G(10), G(6), and G(14) during four cycles (N/8 cycles) corresponding to the second phase 1100b. During these four cycles, the ping buffer 1012 provides input samples 900 G(0), G(12), G(4), and G(8). In some examples, G(0) is provided after G(12) and G(4), or G(8) is provided before G(12) and G(4). As described above, G(0) and G(8) are each processed alone by the conjugate symmetric combiner 516, and G(12) and G(4) (G(k) and G(N/2−k)) are processed together (combined) by the conjugate symmetric combiner 516.

In a first output cycle (a second cycle of the second phase 1100b) the conjugate symmetric combiner 516 provides X(0) to the output of the system 1000. In a second output cycle (a third cycle of the second phase 1100b) the conjugate symmetric combiner 516 provides a second output sample, such as X(4) (X(k)), to the second delay circuit 1010, and provides a third output sample, such as X(12) (X(N/2−k)), to the output of the system 1000. In a third output cycle (a fourth cycle of the second phase 1100b) the conjugate symmetric combiner 516 provides no output, and the second delay circuit 1010 provides the second output sample to the output of the system 1000. In a fourth output cycle (a first cycle of a third phase 1100c, FIG. 11C) the conjugate symmetric combiner 516 provides X(8) (X(N/4)) to the output of the system 1000.

FIG. 11C is a functional block diagram of a view of the system 1000 corresponding to the third phase 1100c of the example radix-2 process 1100 for determining an N-point real FFT. The third phase 1100c corresponds to the third quarter 906 of input samples 900. The view corresponding to the third phase 1100c includes the FFT engine 604, the ping buffer 1012, the pong buffer 1014, the first delay circuit 1008, the second delay circuit 1010, and the conjugate symmetric combiner 516.

The FFT engine 604 provides the third quarter 906 of input samples 900 to the ping buffer 1012, which stores the received input samples 906. Concurrently, the pong buffer 1014 provides the second quarter 904 of input samples 900, alternatingly in sequence, to the first delay circuit 1008 and to the second input of the conjugate symmetric combiner 516. The first delay circuit 1008 outputs the received second quarter samples 904 to the first input of the conjugate symmetric combiner 516 after the delay.

In some examples, the FFT engine 604 provides, and the ping buffer 1012 receives and stores, input samples 900 in bit-reversed index sequential order 900 G(1), G(9), G(5), and G(13). Samples are received and stored during four cycles (N/8 cycles) corresponding to the third phase 1100c. During these four cycles, the pong buffer 1012 provides input samples 900 G(2), G(14), G(6), and G(10). As described above, G(2) and G(14) are processed together by the conjugate symmetric combiner 516, and G(6) and G(10) are processed together by the conjugate symmetric combiner 516 as corresponding pairs (G(k) and G(N/2−k)) of input samples 900.

In a first output cycle (a second cycle of the third phase 1100c) the conjugate symmetric combiner 516 provides a first output sample, such as X(2) (X(k)), to the second delay circuit 1010, and provides a second output sample, such as X(14) ((X(N/2−k)), to the output of the system 1000. In a second output cycle (a third cycle of the third phase 1100c) the conjugate symmetric combiner 516 provides no output, and the second delay circuit 1010 provides the second output sample to the output of the system 1000. In a third output cycle (a fourth cycle of the third phase 1100c) the conjugate symmetric combiner 516 provides a third output sample, such as X(6), to the output of the system 1000, and provides a fourth output sample, such as X(10), to the second delay circuit 1010. In a fourth output cycle (a first cycle of the fourth phase 1100d, FIG. 11D) the conjugate symmetric combiner 516 provides no output, and the second delay circuit 1010 provides the fourth output sample to the output of the system 1000.

FIG. 11D is a functional block diagram of a view of the system 1000 corresponding to the fourth phase 1100d of the example radix-2 process 1100 for determining an N-point real FFT. The fourth phase 1100d corresponds to the fourth quarter 908 of input samples 900. The view corresponding to the fourth phase 1100d includes the FFT engine 604, the ping buffer 1012, the pong buffer 1014, the first delay circuit 1008, and the conjugate symmetric combiner 516.

Starting on a first cycle of the fourth phase 1100d, the FFT engine 604 provides the fourth quarter 908 of input samples 900 to the first delay circuit 1008. Starting on a second cycle of the fourth phase 1100d, the ping buffer 1012 provides the third quarter 904 of input samples 900 to the second input of the conjugate symmetric combiner 516. The first delay circuit 1008 outputs the received fourth quarter samples 908 to the first input of the conjugate symmetric combiner 516 after the delay, starting on the second cycle of the fourth phase 1100d.

In some examples, the ping buffer 1012 sequentially provides input samples 900 G(13), G(5), G(9), and G(1) to the conjugate symmetric combiner 516, accordingly, an opposite order to that in which the input samples 900 were received. Flipping the order in which the input samples 900 are provided enables matching pairs of input samples 900 (G(k) and G(N/2−k)) to be processed together by the conjugate symmetric combiner 516.

The FFT engine 604 provides input samples in bit-reversed index sequential order 900 G(3), G(11), G(7), and G(15) to the first delay circuit 1008. Pairs of input samples 900 G(13) and G(3), G(5) and G(11), G(9) and G(7), and G(1) and G(15) are respectively processed together by the conjugate symmetric combiner 516.

As described above, the system 1000 provides one output sample per cycle. However, during the fourth phase 1100d, the conjugate symmetric combiner 516 receives two input samples 900 per cycle for four (N/8) consecutive cycles. This results in two output samples being produced by the conjugate symmetric combiner 516 each cycle for four consecutive cycles.

Accordingly, half of the output samples that are produced during the fourth phase 1100d are provided to and stored by the pong buffer 1014, and then provided by the pong buffer 1014 as output of the system 1000 during the second, third, and fourth cycles of the first phase 1100a (2) (FIG. 11E) and the first cycle of the second phase 1100b of the next (second or subsequent) iteration of the process 1100. For example, output samples X(3), X(11), X(7), and X(15) are output by the system 1000 after being generated by the conjugate symmetric combiner 516, and output samples X(13), X(5), X(9), and X(1) are provided to the pong buffer 1014 and then output by the system 1000 during subsequent cycles.

FIG. 11E is a functional block diagram of a view of the system 1000 corresponding to the first phase 1100a (2) in second and later iterations of the example radix-2 process 1100 for determining an N-point real FFT. The first phase 1100a (2) corresponds to the first quarter 902 of input samples 900. The view corresponding to the first phase 1100c of the second (or later) iteration includes the FFT engine 604, the ping buffer 1012, and the pong buffer 1014.

During the first phase 1100a (2) of the second or later iteration, the FFT engine 604 provides the first quarter 902 of the input samples 900 to the ping buffer 1012, as described with respect to FIG. 11A, accordingly, with respect to the first phase 1100a (1) in the first iteration. Output samples provided by the pong buffer 1014 to the output of the system 1000 are described with respect to FIG. 11D, accordingly, with respect to the fourth phase 1100d. In some examples, these output samples provided by the pong buffer 1014 to the output of the system 1000 can be described as being provided as part of the first phase 1100a (2) of the second or later iteration of the process 1100.

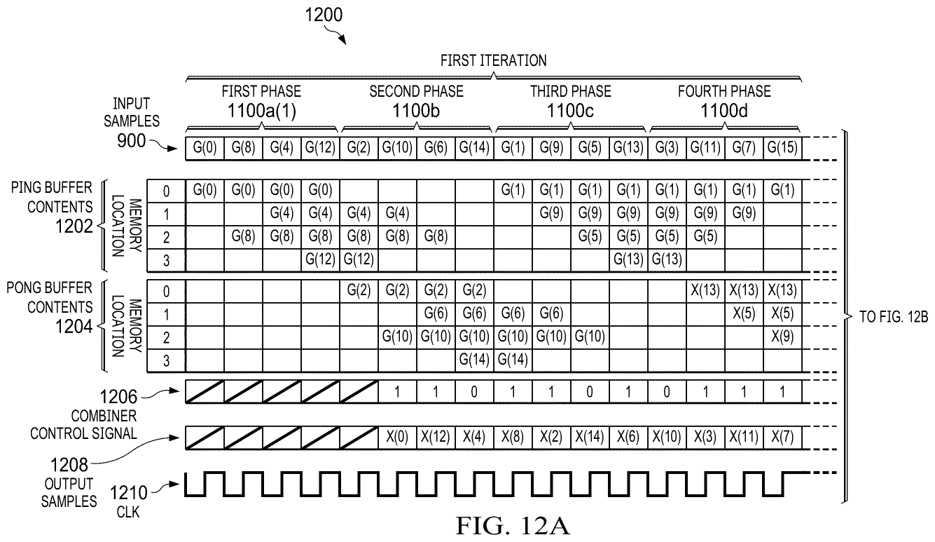

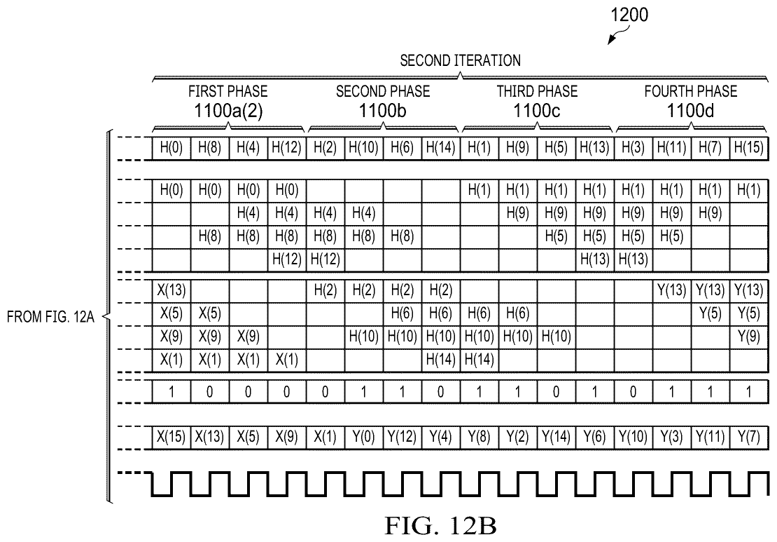

FIG. 12A is a table 1200 showing input samples 900, contents of the ping buffer 1202, contents of the pong buffer 1204, a combiner control signal 1206, output samples 1208, and the clock signal (CLK) 1210. FIG. 12B is a continuation of the table of FIG. 12A. Input samples 900 for the first iteration of the process 1100 are represented as G(k), and input samples 900 for the second iteration of the process 1100 are represented as H(k). G(k) and H(k) are received from the FFT engine 604. Output samples for the first iteration of the process 1100 are represented as X(k), and output samples for the second iteration of the process 1100 are represented as Y(k). X(k) and Y(k) are generated by the conjugate symmetric combiner 516, and are provided to the output of the system 1000 either by the conjugate symmetric combiner 516 or by the pong buffer 1014. In some examples, a memory location in the ping buffer 1012 or the pong buffer 1014 in which an input sample 900 is stored is responsive to memory design.

In some examples, the combiner control signal 1206 is provided by the FFT control circuit 1004. In cycles prior to the conjugate symmetric combiner 516 providing output samples (accordingly, only in the first iteration of the process 1100), the combiner control signal 1206 and the output samples 1208 signal are respectively don't-care or NULL signals. A don't-care or NULL signal is indicated by a slash through a corresponding space. After output samples first become available, the combiner control signal 1206 is a logic zero on cycles during which the conjugate symmetric combiner 516 is not ready to provide output samples, and the combiner control signal 1206 is a logic one on cycles during which the conjugate symmetric combiner 516 is ready to provide output samples. Ordering of output samples is described with respect to FIGS. 11B through 11E.

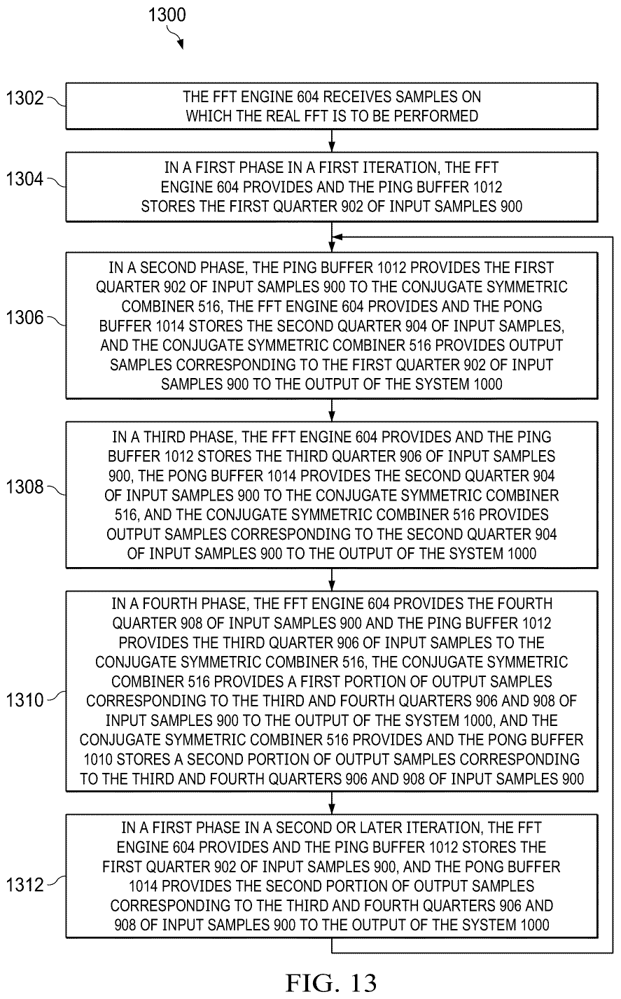

FIG. 13 is a flow diagram of a radix-2 process 1300 for determining an N-point real FFT. In step 1302, the FFT engine 604 receives samples on which the real FFT is to be performed. In step 1304, corresponding to a first phase in a first iteration, the FFT engine 604 provides and the ping buffer 1012 stores the first quarter 902 of input samples 900. Method 1300 orders (e.g., arranges) input data flow through the conjugate symmetric combiner 516 (e.g., one-sample-per-cycle input data flow) to enable the system 1000 to provide a radix-2 real FFT output data flow (e.g., one-sample-per-cycle real FFT output data flow). Similarly, method 1800 orders input data flow through the conjugate symmetric combiner 516 to enable the system 1000 to provide a radix-3 real FFT output data flow, and method 2200 orders input data flow through the conjugate symmetric combiner 516 to enable the system 1000 to provide a radix-2 real IFFT output data flow.

In step 1306, corresponding to a second phase, three functions are performed (in some examples, concurrently). The ping buffer 1012 provides the first quarter 902 of input samples 900 to the conjugate symmetric combiner 516. The conjugate symmetric combiner 516 provides output samples corresponding to the first quarter 902 of input samples 900 to the output of the system 1000. The FFT engine 604 provides and the pong buffer 1014 stores the second quarter 904 of input samples 900.

In step 1308, corresponding to a third phase, three functions are performed (in some examples, concurrently). The FFT engine 604 provides and the ping buffer 1012 stores the third quarter 906 of input samples 900. The pong buffer 1014 provides the second quarter 904 of input samples 900 to the conjugate symmetric combiner 516. The conjugate symmetric combiner 516 provides output samples corresponding to the second quarter 904 of input samples 900 to the output of the system 1000.

In step 1310, corresponding to a fourth phase, three functions are performed (in some examples, concurrently). The FFT engine 604 provides the fourth quarter 908 of input samples 900, and the ping buffer 1012 provides the third quarter 906 of input samples, to the conjugate symmetric combiner 516. The conjugate symmetric combiner 516 provides a first portion of output samples corresponding to the third and fourth quarters 906 and 908 of input samples 900 to the output of the system 1000. The conjugate symmetric combiner 516 provides and the pong buffer 1014 stores a second portion of output samples corresponding to the third and fourth quarters 906 and 908 of input samples 900.

In step 1312, corresponding to a first phase in a second or later iteration, the FFT engine 604 provides and the ping buffer 1012 stores the first quarter 902 of input samples 900, and the pong buffer 1014 provides the second portion of output samples corresponding to the third and fourth quarters 906 and 908 of input samples 900 to the output of the system 1000. After step 1312, the process 1300 returns to step 1306.

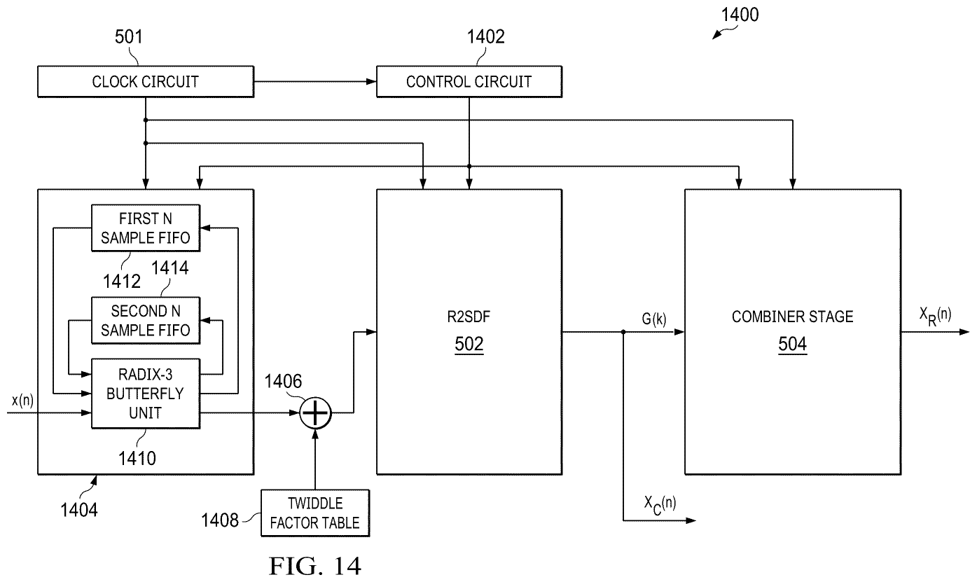

FIG. 14 is a functional block diagram of a fourth example system 1400 for selectably determining a real FFT or a complex FFT. The system 1400 uses a radix-3 approach to determining the FFT. The system 1400 can be used as an FFT engine 604 to determine 3N-point DFTs. Accordingly, as described above, the system 1400 can also be used to determine a real IFFT or a complex IFFT. The system 1400 includes a clock circuit 501, a control circuit 1402, a radix-3 (R3) butterfly stage 1404, a multiplier 1406, a twiddle factor table 1408, an R2SDF 502, and a combiner stage 504. The R3 butterfly stage 1404 includes an R3 butterfly unit 1410, a first N sample FIFO memory 1412, and a second N sample FIFO memory 1414.

The clock circuit 501 provides a clock signal to the control circuit 1402, the R3 butterfly stage 1404, the R2SDF 502, and the combiner stage 504. The control circuit 1402 is connected to control the R3 butterfly stage 1404, the R2SDF 502, and the combiner stage 504.

A first input of the R3 butterfly unit 1410 receives input samples x(n), such as input samples 1500 (FIG. 15). A first output of the R3 butterfly unit 1410 is connected to a first input of the multiplier 1406, and an output of the twiddle factor table 1408 is connected to a second input of the multiplier 1406. A second output of the R3 butterfly unit 1410 is connected to an input of the first N sample FIFO memory 1412, and a third output of the R3 butterfly unit 1410 is connected to an input of the second N sample FIFO memory 1414. An output of the first N sample FIFO memory 1412 is connected to a second input of the R3 butterfly unit 1410, and an output of the second N sample FIFO memory 1414 is connected to a third input of the R3 butterfly unit 1410.

An output of the multiplier 1406 is connected to an input of the R2SDF 502. An output of the R2SDF 502 is connected to an input of the combiner stage 504. The R2SDF 502 provides complex FFT output samples X_{C}(n), or combiner stage 504 input samples G(k) for real FFT processing, responsive to control signals provided by the control circuit 1402. Accordingly, samples X_{C}(n) or G(k) are provided responsive to whether the system 1400 is used to perform a complex FFT or a real FFT, respectively.

Equations 4 through 10 also may apply to determining a real FFT by using the system 1400 to perform a radix-3 FFT process. Accordingly, the conjugate symmetric combiner 516 implementation 800 of FIG. 8 can be used in the system 1400.

FIG. 15 is a set of input samples 1500 provided by the FFT engine 604 of FIGS. 6A and 14 to be processed by the conjugate symmetric combiner 516 of FIGS. 5 and 6A to determine an FFT of the input samples 1500 using a radix-3 approach. In some examples, the input samples 1500 are used by the system 1400 of FIG. 14 to perform an FFT using a radix-3 approach.

3N-point radix-3 FFT is described herein. In some examples, such as examples in which the FFT engine 604 includes an R2SDF 502, the FFT engine 604 receives 3N samples x(n), and provides 3N/2 input samples (G(k)) 1500 to the conjugate symmetric combiner 516. The input samples 1500 provided to the conjugate symmetric combiner 516 are bit-reversed with respect to the samples x(n) received by the FFT engine 604. In the example illustrated in FIG. 15, N equals 16, so that there are 24 (3N/2) input samples 1500.

The input samples 1500 are divided into three thirds, accordingly, a first third 1502, a second third 1504, and a third third 1506. The first third 1502 includes, sequentially, G(0), G(12), G(6), G(18), G(3), G(15), G(9), and G(21). The second third 1504 includes, sequentially G(1), G(13), G(7), G(19), G(4) G(16), G(10), and G(22). The third third 1506 includes, sequentially, G(2), G(14), G(8), G(20), G(5), G(17), G(11), and G(23).

Pairs of input samples 1500 that are processed together (combined) by the conjugate symmetric combiner 516 are indicated by pairing lines 1508. Accordingly, G(0) and G(12) (G(3N/4)) are processed alone, and a few example pairs of input samples 1500 G(k) and G(3N/2-k) are: G(6) and G(18), G(3) and G(21), and G(15) and G(9).

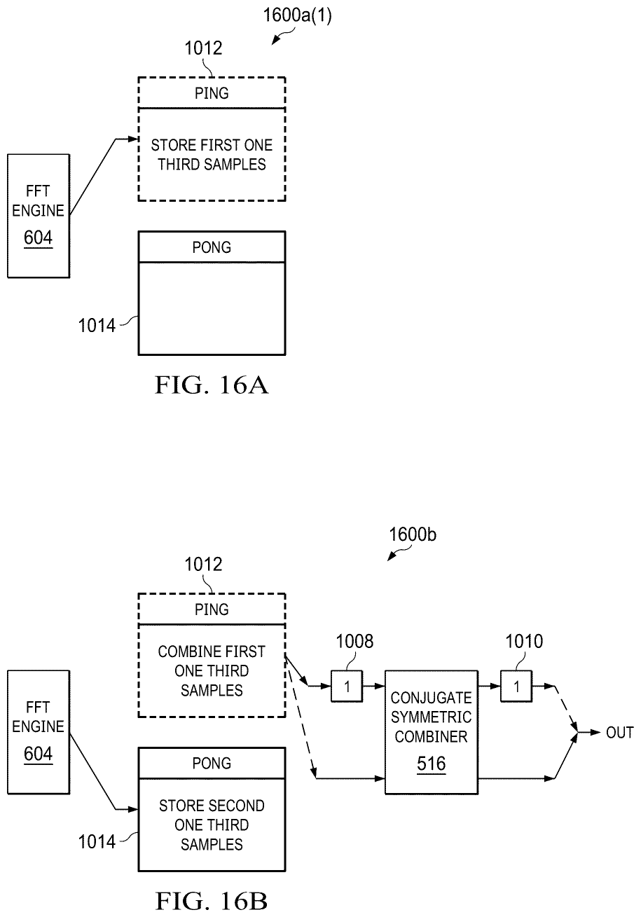

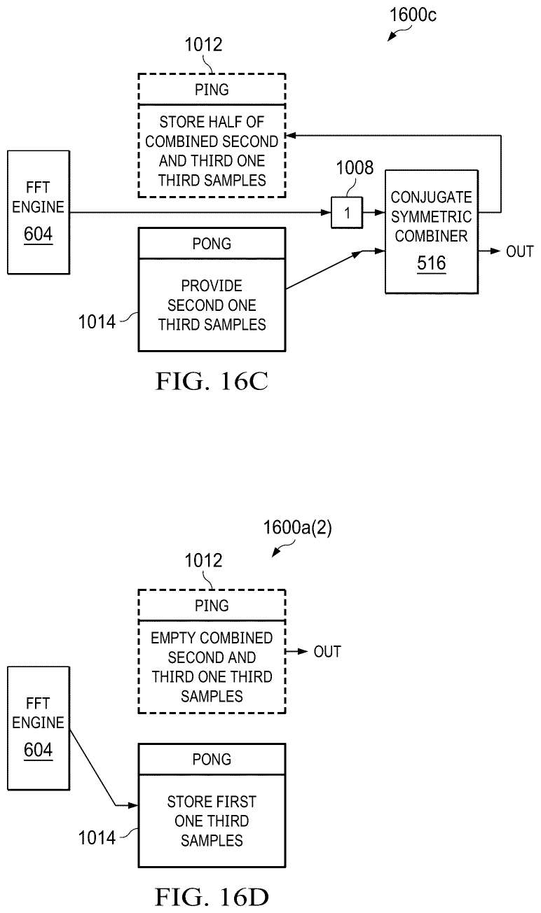

FIG. 16A is a functional block diagram of a view of the system 1400 corresponding to a first phase 1600a (1) in a first iteration of an example radix-3 process 1600 for determining a 3N-point real FFT. The process 1600 includes three phases 1600a, 1600b, and 1600c. Each phase 1600a, 1600b, and 1600c in the process 1600 corresponds to providing one third 1502, 1504, or 1506 of the 3N/2 input samples 1500 to the conjugate symmetric combiner 516 and/or the ping-pong buffer 518. The first iteration of the process 1600 corresponds to performance of the process 1600 after the system 1000 is reset (accordingly, volatile memory, such as ping-pong buffers 518, is cleared), such as in response to device power on. The first phase 1600a (1) is handled differently for the first iteration of the process 1600 than in later iterations of the process 1100.

The view corresponding to the first iteration of the first phase 1600a (1) includes the FFT engine 604, the ping buffer 1012, and the pong buffer 1014. During the first iteration of the first phase 1600a (1), the FFT engine 604 provides and the ping buffer 1012 stores the first N/2 input samples 1500, corresponding to the first third 1502 of input samples 1500. In the illustrated example, FFT engine 604 provides, and the ping buffer 1012 receives and stores, input samples 1500 in bit-reversed sequential index order: G(0), G(12), G(6), G(18), G(3), G(15), G(9), and G(21).

FIG. 16B is a functional block diagram of a view of the system 1400 corresponding to a second phase 1600b of the example radix-3 process 1600 for determining a 3N-point real FFT. The second phase 1600b corresponds to the second third 1504 of input samples 1500. The view corresponding to the second phase 1600b includes the FFT engine 604, the ping buffer 1012, the pong buffer 1014, the first delay circuit 1008, the second delay circuit 1010, and the conjugate symmetric combiner 516.

The ping buffer 1012 alternatingly provides the first third 1502 of input samples 1500 to the first delay circuit 1008 and the second input of the conjugate symmetric combiner 516. Accordingly, the ping buffer 1012 provides, sequentially, G(0), G(12), G(6), G(18), G(3), G(15), G(9), and G(21). The FFT engine 604 provides the second third 1504 of input samples 1500 to the pong buffer 1014, which stores the received input samples 1500. Accordingly, the FFT engine 604 provides, and the pong buffer 1014 receives and stores, in bit-reversed index sequential order, G(1), G(13), G(7), G(19), G(4), G(16), G(10), and G(22).

In a first output cycle (a second cycle) of the second phase 1600b the conjugate symmetric combiner 516 provides X(0) to the output of the system 1000. The conjugate symmetric combiner 516 then outputs pairs of output samples ((X(k) and (X(N/2−k)) on alternating cycles. One output sample of each such pair is provided to the output of the system 1000, and the other output sample is provided to the second delay circuit 1010 to be provided to the output of the system 1000 on the sequentially next cycle. X(12) (X(N/4)) is provided to the output of the system 1000 on a last output cycle (N/2th output cycle) of the second phase 1600b, corresponding to a first cycle of the third phase 1600c.

FIG. 16C is a functional block diagram of a view of the system 1000 corresponding to a third phase 1600c of the example radix-3 process 1600 for determining a 3N-point real FFT. The view corresponding to the third phase 1600c includes the FFT engine 604, the ping buffer 1012, the pong buffer 1014, the first delay circuit 1008, and the conjugate symmetric combiner 516.

The ping buffer 1012 sequentially provides the second third 1504 of input samples 1500 to the second input of the conjugate symmetric combiner 516. The FFT engine 604 provides the third third 1506 of input samples 1500 to the first delay circuit 1008 in bit-reversed index sequential order, accordingly, G(2), G(14), G(8), G(20), G(5), G(17), G(11), and G(23). Pairs of input samples 1500 G(1) and G(23), G(13) and G(11), G(7) and G(17), G(19) and G(5), G(4) and G(20), G(16) and G(8), G(10) and G(14), and G(22) and G(2) are respectively processed together by the conjugate symmetric combiner 516.

As described above, the system 1000 provides one output sample per cycle. However, during the third phase 1600c, the conjugate symmetric combiner 516 receives two input samples 900 per cycle for eight (N/2) consecutive cycles. This results in two output samples being produced by the conjugate symmetric combiner 516 each cycle for eight consecutive cycles.

Accordingly, half of the output samples that are produced during the third phase 1600c are provided to and stored by the ping buffer 1012, and then provided by the ping buffer 1012 as output of the system 1000 from the second cycle of the first phase 1600a (2) (FIG. 16D) through the first cycle of the second phase 1600b of the next (second or subsequent) iteration of the process 1600. For example, output samples X(2), X(14), X(8), X(20), X(5), X(17), X(11), and X(23) are output by the system 1000 after being generated by the conjugate symmetric combiner 516, and output samples X(22), X(10), X(16), X(4), X(19), X(7), X(13), and X(1) are provided to the ping buffer 1012 and then output by the system 1000 during subsequent cycles.

FIG. 16D is a functional block diagram of a view of the system 1000 corresponding to a first phase 1600a (2) in a second or later iteration of the example radix-3 process 1600 for determining a 3N-point real FFT. The view corresponding to the second or later iteration of the first phase 1600a (2) includes the FFT engine 604, the ping buffer 1012, and the pong buffer 1014.

The FFT engine 604 provides the first third 1502 of the input samples 1500 to the pong buffer 1014. Notice that the pong buffer 1014 has switched roles with the ping buffer 1012 with respect to the first phase 1600a (1) in the first iteration. The pong buffer 1014 provides the second third 1504 of the input samples 1500 to the second input of the conjugate symmetric combiner 516. Meanwhile, as discussed with respect to the third phase 1600c (FIG. 16C), the ping buffer 1012 provides the overflow output samples it stored during the third phase 1600c to the output of the system 1000. In some examples, these output samples provided by the pong buffer 1014 to the output of the system 1000 can be described as being provided as part of the first phase 1600a (2) of the second or later iteration of the process 1600.

During iterations of the process 1600 after the first iteration, the roles of the ping buffer 1012 and the pong buffer 1014 alternate. In odd-numbered iterations, the ping buffer 1012 and the pong buffer 1014 store and provide input samples 1500 and output samples as described with respect to FIGS. 16A through 16C, and the pong buffer 1014 provides output samples to the output of the system 1000 as described with respect to the ping buffer 1012 in FIG. 16C.

In even-numbered iterations, the ping buffer 1012 and pong buffer 1014 act as described with respect to FIG. 16D in the first phase 1600a (2). In the second phase 1600b, the ping buffer 1012 stores the second third 1504 of input samples 1500 and the pong buffer 1014 provides the first third 1502 of input samples 1500 to the first delay circuit 1008 and the conjugate symmetric combiner 516. In the third phase 1600c, the ping buffer 1012 provides the second third 1504 of input samples 1500 to the conjugate symmetric combiner 516, and the pong buffer 1014 stores overflow output samples. The pong buffer 1014 subsequently provides the overflow output samples to the output of the system 1000.

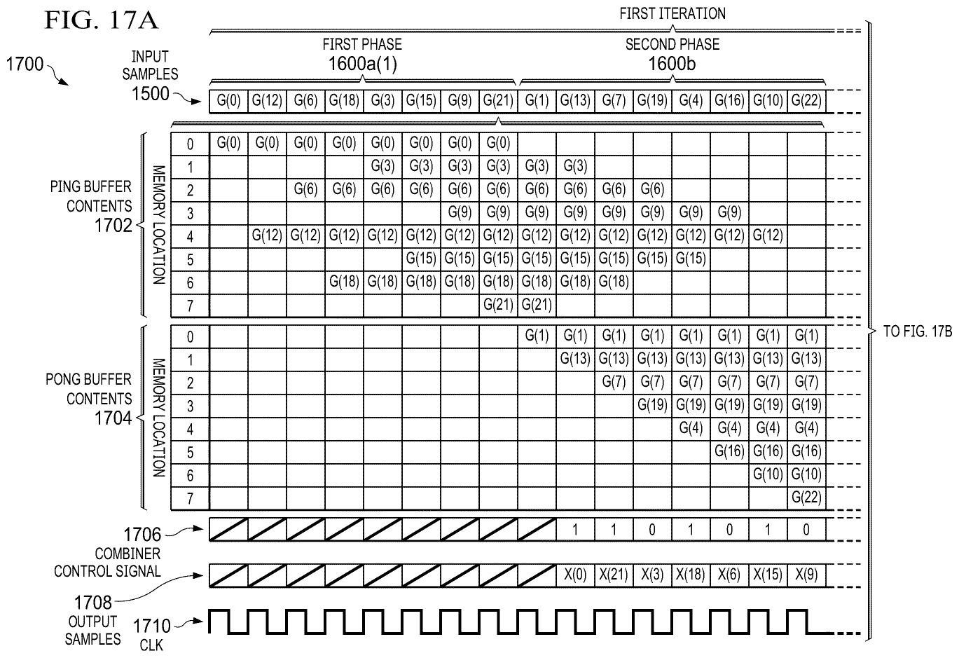

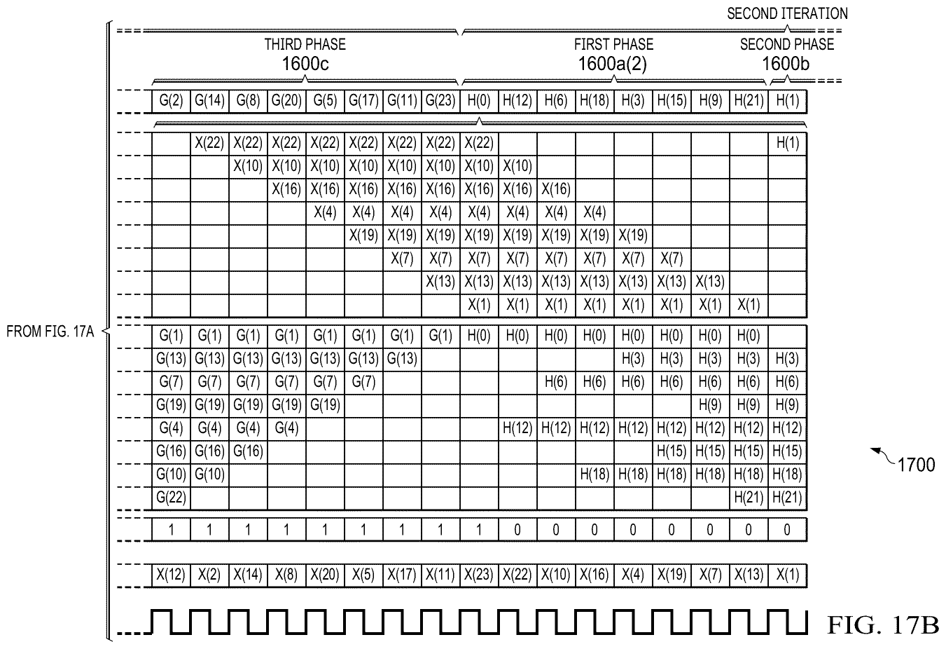

FIG. 17A is a table 1700 showing input samples 1500, contents of the ping buffer 1702, contents of the pong buffer 1704, a combiner control signal 1706, output samples 1708, and the clock signal (CLK) 1710. FIG. 17B is a continuation of the table of FIG. 17A. Input samples 1500 for the first iteration of the process 1600 are represented as G(k), and input samples 1500 for the second iteration of the process 1600 are represented as H(k). G(k) and H(k) are received from the FFT engine 604. Output samples for the first iteration of the process 1600 are represented as X(k), and output samples for the second iteration of the process 1600 are represented as Y(k). X(k) and Y(k) are generated by the conjugate symmetric combiner 516, and are provided to the output of the system 1000 by the conjugate symmetric combiner 516, the ping buffer 1012, or the pong buffer 1014. In some examples, a memory location in the ping buffer 1012 or the pong buffer 1014 in which an input sample 1500 is stored is responsive to memory design.

In some examples, the combiner control signal 1706 is provided by the FFT control circuit 1004. In cycles prior to the conjugate symmetric combiner 516 providing output samples (accordingly, only in the first iteration of the process 1600), the combiner control signal 1706 and the output samples 1708 signal are respectively don't-care or NULL signals. A don't-care or NULL signal is indicated by a slash through a corresponding space. After output samples first become available, the combiner control signal 1706 is a logic zero on cycles during which the conjugate symmetric combiner 516 is not ready to provide output samples, and the combiner control signal 1706 is a logic one on cycles during which the conjugate symmetric combiner 516 is ready to provide output samples. Ordering of output samples is described with respect to FIGS. 16B through 16D.

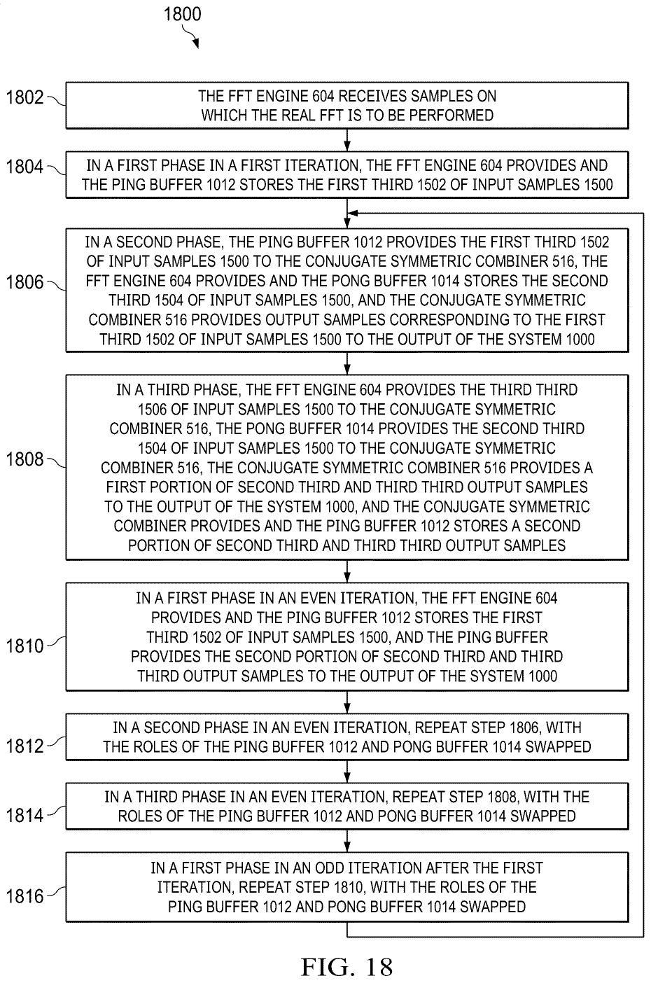

FIG. 18 is a flow diagram of an example radix-3 process 1800 for determining a 3N-point real FFT. In step 1802, the FFT engine 604 receives samples on which the real FFT is to be performed. In step 1804, corresponding to a first phase in a first iteration, the FFT engine 604 provides and the ping buffer 1012 stores the first third 1502 of input samples 1500. In step 1806, corresponding to a second phase, the ping buffer 1012 provides the first third 1502 of input samples 1500 to the conjugate symmetric combiner 516, the FFT engine 604 provides and the pong buffer 1014 stores the second third 1504 of input samples 1500, and the conjugate symmetric combiner 516 provides output samples corresponding to the first third 1502 of input samples 1500 to the output of the system 1000.

In step 1808, corresponding to a third phase, the FFT engine 604 provides the third third 1506 of input samples 1500 to the conjugate symmetric combiner, the pong buffer 1014 provides the second third 1504 of input samples 1500 to the conjugate symmetric combiner 516, the conjugate symmetric combiner provides a first portion of output samples corresponding to the second and third thirds 1504 and 1506 of input samples 1500 to the output of the system 1000, and the conjugate symmetric combiner 516 provides a second portion of output samples corresponding to the second and third thirds 1504 and 1506 of input samples 1500 to the ping buffer 1012.

In step 1810, corresponding to a first phase in an even numbered iteration (such as second, fourth, sixth, etc.), the FFT engine 604 provides and the pong buffer 1014 stores the first third 1502 of input samples 1500, and the ping buffer 1012 provides the second portion of output samples corresponding to the second and third thirds 1504 and 1506 of input samples 1500 to the output of the system 1000. In step 1812, corresponding to a second phase in an even numbered iteration, step 1806 is repeated, with the roles of the ping buffer 1012 and the pong buffer 1014 swapped. In step 1814, corresponding to a third phase in an even numbered iteration, step 1808 is repeated, with the roles of the ping buffer 1012 and the pong buffer 1014 swapped.

In step 1816, corresponding to a first phase in an odd numbered iteration after the first iteration (such as third, fifth, seventh, etc.), step 1810 is repeated, with the roles of the ping buffer 1012 and the pong buffer 1014 swapped. After step 1816, the process 1800 proceeds from step 1804.

FIG. 19 is a set of input samples 1900 to be processed by the conjugate symmetric combiner 516 of FIGS. 5 and 6A to determine a real IFFT of the input samples 1500 using a radix-2 approach. Accordingly, the FFT engine 604 uses a radix-2 approach to determine a complex IFFT, and is, for example, an R2SDF 502. In some examples, the input samples 1900 are provided by a memory such as the memory 120.

The input samples 1900 are processed in two phases, corresponding to a first half 1902 of the input samples 1900 and a second half 1904 of the input samples 1900. Recall, as described with respect to Equation 15, that input samples 1900 for an IFFT process correspond to X(k), accordingly, output samples for an FFT process. Also, in some examples, IFFT input samples 1900 may be provided in any order.

The first half 1902 of the input samples 1900 are samples X(k), where k=N/4 to N/2−1. The second half 1904 of the input samples 1900 are samples X(k), where k=0 to N/4-1. Providing input samples 1900 in this order enables address generation to be simple. In some examples, this enables the ping buffer 1012 and the pong buffer 1014 to be treated as last-in-first-out (LIFO) memories for the purpose of real IFFT according to the process 2000 (FIGS. 20A through 20C.

In the illustrated example of FIG. 19, in which N=32, the first half 1902 of the input samples 1900 includes, sequentially, X(8), X(9), X(10), X(11), X(12), X(13), X(14), and X(15). The second half 1904 of the input samples 1900 includes, sequentially, X(0), X(1), X(2), X(3), X(4), X(5), X(6), and X(7). The ordering of the input samples 1900 corresponds to an index sequential order that is circularly shifted by N/4. Linking lines 1906 indicate pairs of input samples 1900 that are processed together (combined) by the conjugate symmetric combiner 516.

FIG. 20A is a functional block diagram of a view of the system 1000 corresponding to a first phase 2000a (1) in a first iteration of an example radix-2 process 2000 for determining an N-point real IFFT. The view corresponding to the first phase 2000a (1) includes the ping buffer 1012, the pong buffer 1014, the conjugate symmetric combiner 516, a conjugate block 2002 (which provides a complex conjugate of its input), and the FFT engine 604. In some examples, the conjugate block 2002 is connected to communicate with the switching network 1002 of FIG. 10. Solid lines indicate data paths used during a corresponding phase, and dotted lines indicate data paths used during a different phase or during a later iteration of the process 2000. In some examples, a radix-3 process for determining a 3N-point real IFFT can be performed similarly to a radix-2 process for determining an N-point real IFFT.

In the first iteration of the first phase 2000a (1), the ping buffer 1012 receives and stores the first half 1902 of the input samples 1900. Accordingly, the ping buffer 1012 receives and stores, sequentially, X(8), X(9), X(10), X(11), X(12), X(13), X(14), and X(15). In some examples, the ping buffer 1012 (or in the second phase 2000b, the pong buffer) receives the input samples 1900 from the memory 120 or via an external communication line.

FIG. 20B is a functional block diagram of a view of the system 1000 corresponding to a second phase 2000b of an example radix-2 process 2000 for determining an N-point real IFFT. The view corresponding to the second phase 2000b includes the ping buffer 1012, the pong buffer 1014, the conjugate symmetric combiner 516, the conjugate block 2002, and the FFT engine 604. In the second phase 2000b, the ping buffer 1012 provides the stored first half 1902 of the input samples 1900 to the first input of the conjugate symmetric combiner 516, and the second input of the conjugate symmetric combiner 516 receives the second half 1904 of the input samples 1900.

Accordingly, the conjugate symmetric combiner 516 receives N/2 input samples 1900 in N/4 cycles. In response, the conjugate symmetric combiner 516 generates N/2 intermediate samples in N/4 cycles for further processing by the conjugate block 2002 and the FFT engine 604. The conjugate symmetric combiner 516 provides N/4 of the intermediate samples to the conjugate block 2002, at a rate of one intermediate sample per cycle, in the first cycle of the second phase 2000b through the last cycle of the second phase 2000b. The conjugate block 2002 provides these samples, multiplied by j, to the FFT engine 604 for further processing as described with respect to Equation 15. The FFT 604 generates real IFFT output samples in response to the intermediate samples.

The conjugate symmetric combiner 516 provides the remaining N/4 of the intermediate samples to the pong buffer 1014. From the first cycle of the first phase 2100a (2) of the second or later iteration through the last cycle of the first phase 2100a (2) of the second or later iteration, the pong buffer 1014 provides the N/4 intermediate samples it stored during the second phase 2100b to the conjugate block 2002. The conjugate block 2002 provides these intermediate samples, multiplied by j, to the FFT engine 604 for further processing as described with respect to Equation 15. Intermediate samples are provided in a same index order as described for input samples 1900 with respect to FIG. 19.

FIG. 20C is a functional block diagram of a view of the system 1000 corresponding to a first phase 2000a (2) of a second or later iteration of an example radix-2 process 2000 for determining an N-point real IFFT. The view corresponding to the second or later iteration of the first phase 2000a (2) includes the ping buffer 1012, the pong buffer 1014, the conjugate symmetric combiner 516, the conjugate block 2002, and the FFT engine 604.

The FFT engine 604 provides the first half 1902 of the input samples 1900 to the ping buffer 1012. As described with respect to FIG. 20B, the pong buffer 1014 provides the second half of the intermediate samples (overflow intermediate samples), generated during the second phase 2000b of the sequentially previous iteration, to the conjugate block 2002.

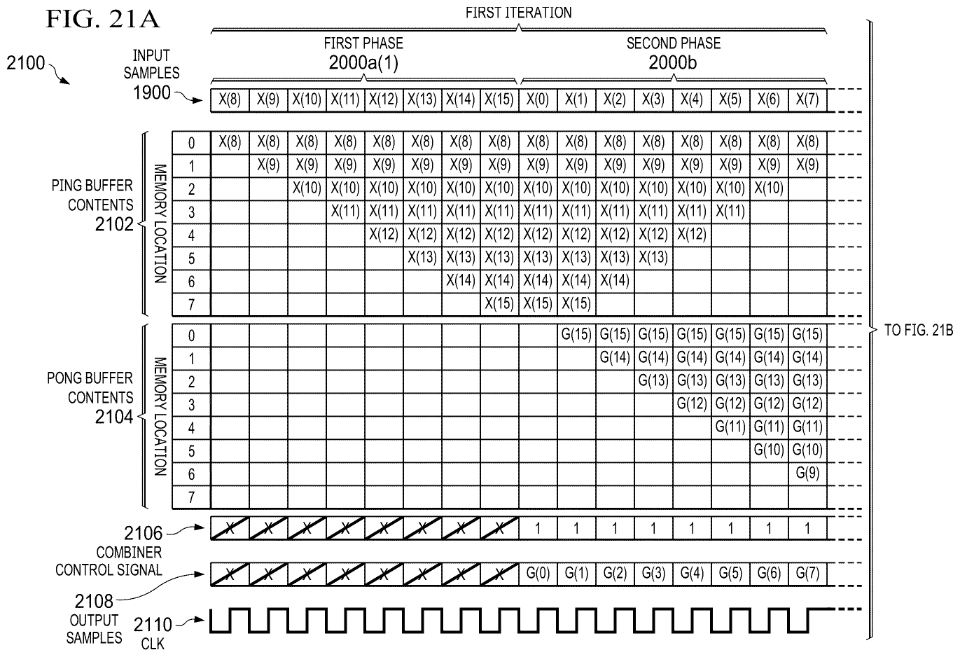

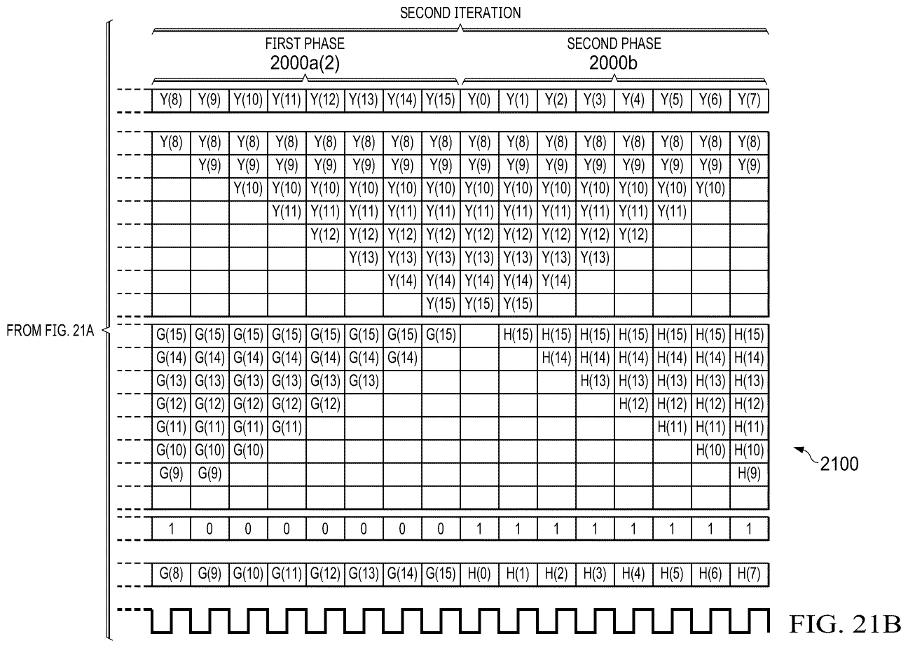

FIG. 21A is a table 2100 showing input samples 1900, contents of the ping buffer 2102, contents of the pong buffer 2104, a combiner control signal 2106, output samples (intermediate samples) 2108 provided to the conjugate block 2002, and the clock signal (CLK) 2110. FIG. 21B is a continuation of the table of FIG. 12A. Input samples 1900 for the first iteration of the process 2000 are represented as X(k), and input samples 1900 for the second iteration of the process 2000 are represented as Y(k). X(k) and Y(k) are received as input to the system 1000, such as from the memory 120 (or other memory). Output samples (intermediate samples) for the first iteration of the process 2000 are represented as G(k), and output samples for the second iteration of the process 2000 are represented as H(k). G(k) and H(k) are provided to the FFT engine 604, which generates output samples x(n) of the system 1000. The output x(n) corresponds to the real IFFT of input samples of the system 1000 such as X(k) and Y(k). In some examples, a memory location in the ping buffer 1012 or the pong buffer 1014 in which an input sample 900 is stored is responsive to memory design.

In some examples, the combiner control signal 2106 is provided by the FFT control circuit 1004. In cycles prior to the conjugate symmetric combiner 516 providing output samples (accordingly, only in the first iteration of the process 2000), the combiner control signal 2106 and the output samples 2108 signal are respectively don't-care or NULL signals. A don't-care or NULL signal is indicated by a slash through a corresponding space. After output samples first become available, the combiner control signal 2106 is a logic zero on cycles during which the conjugate symmetric combiner 516 is not ready to provide output samples, and the combiner control signal 2106 is a logic one on cycles during which the conjugate symmetric combiner 516 is ready to provide output samples. Ordering of output samples is described with respect to FIG. 20B.

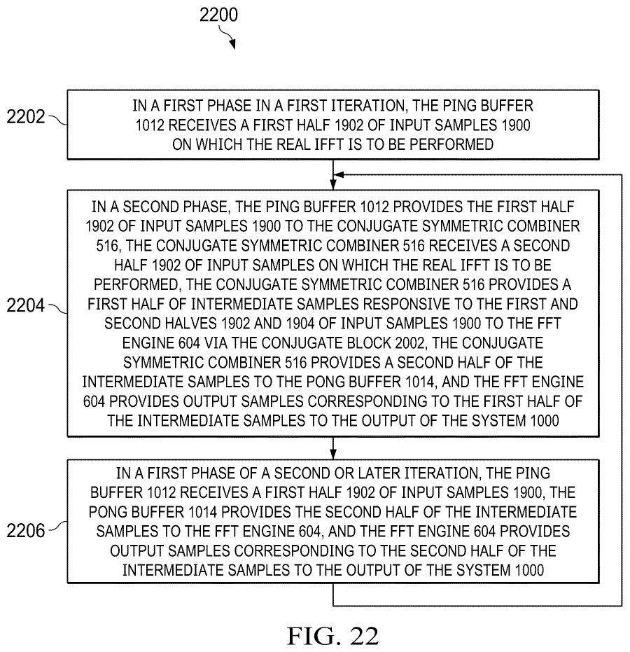

FIG. 22 is a flow diagram of an example radix-2 process 2200 for determining an N-point real IFFT. In step 2202, corresponding to a first phase of a first iteration, the ping buffer 1012 receives a first half 1902 of input samples 1900 on which the real IFFT is to be performed. In step 2204, corresponding to a second phase, the conjugate symmetric combiner 516 receives a second half 1904 of input samples 1900 on which the real IFFT is to be performed, the ping buffer 1012 provides the first half 1902 of input samples 1900 to the conjugate symmetric combiner 516, the conjugate symmetric combiner 516 provides a first half of intermediate samples responsive to the first and second halves 1902 and 1904 of input samples 1900 to the FFT engine 604 via the conjugate block 2002, the conjugate symmetric combiner 516 provides a second half of the intermediate samples to the pong buffer 1014, and the FFT engine 604 provides output samples corresponding to the first half 1902 of the intermediate samples to the output of the system 1000.

In step 2206, corresponding to a first phase of a second or later iteration, the ping buffer 1012 receives a first half 1902 of input samples 1900, the pong buffer 1014 provides the second half 1904 of the intermediate samples to the FFT engine 604, and the FFT engine 604 provides output samples corresponding to the second half 1904 of the intermediate samples to the output of the system 1000.

Modifications are possible in the described embodiments, and other embodiments are possible, within the scope of the claims.

In some examples, the system 1000, or a portion thereof, is implemented in hardware, such as in a hardware acceleration unit, or is included in or as a processor.

In some examples, such a processor is a central processing unit (CPU), DSP such as the DSP 102, or a microcontroller unit (MCU).

In some examples, the system 1000 is implemented as hardware, software, or a combination of hardware and software.

In some examples, one or more of the processes described herein are implemented as software instructions for execution by a processor. In some examples, such software instructions are stored in a non-transitory memory.

In some examples, the system 1000, or a portion thereof, is included in an integrated circuit (IC) fabricated on a semiconductor die.

In some examples, the FFT control circuit 1004 and/or the memory control circuit 1006 controls the FFT engine 604 and/or the ping buffer 1012 and/or the pong buffer 1014 to provide samples to the conjugate symmetric combiner 516 in a different order than described herein.

In some examples, a different approach than described herein, such as a radix-4 approach, is used to determine a real or complex FFT or IFFT.

In some examples, samples x(n) received by the FFT engine 604 can be described as a stream of samples. In some examples, samples G(k) received by the ping-pong buffer 518 can be described as a stream of samples. In some examples, samples X(k) received by the ping-pong buffer 518 can be described as a stream of samples. In some examples, intermediate samples or output samples generated by the conjugate symmetric combiner 516 can be described as a stream of samples.

In this description, the term “and/or” (when used in a form such as A, B and/or C) refers to any combination or subset of A, B, C, such as: (a) A alone; (b) B alone; (c) C alone; (d) A with B; (e) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

A device that is “configured to” perform a task or function may be configured (for example, programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be adapted to be coupled to those components to form the described circuitry or device. For example, a structure described as including multiple functional blocks may instead include only the functional blocks within a single physical device (for example, a semiconductor die and/or integrated circuit (IC) package) and may be adapted to be coupled to at least some of the functional blocks to form the described structure either at a time of manufacture or after a time of manufacture, for example, by an end-user and/or a third-party.

Circuits described herein are reconfigurable to include the replaced components to provide functionality at least partially similar to functionality available prior to the component replacement.

The term “couple” is used throughout the specification. The term may cover connections, communications, or signal paths that enable a functional relationship consistent with this description. For example, if device A provides a signal to control device B to perform an action, in a first example device A is coupled to device B, or in a second example device A is coupled to device B through intervening component C if intervening component C does not substantially alter the functional relationship between device A and device B such that device B is controlled by device A via the control signal provided by device A.

While certain elements of the described examples may be included in an IC and other elements are external to the IC, in other examples, additional or fewer features may be incorporated into the IC. In addition, some or all of the features illustrated as being external to the IC may be included in the IC and/or some features illustrated as being internal to the IC may be incorporated outside of the IC. As used herein, the term “IC” means one or more circuits that are: (i) incorporated in/over a semiconductor substrate; (ii) incorporated in a single semiconductor package; (iii) incorporated into the same module; and/or (iv) incorporated in/on the same PCB.

Unless otherwise stated, “about,” “approximately,” or “substantially” preceding a value means +/−10 percent of the stated value, or, if the value is zero, a reasonable range of values around zero.

What is claimed is:

1. A circuit device comprising:
a fast Fourier transform (FFT) circuit configured to receive an input set of complex samples and to provide an FFT output set of complex samples; and
a combiner circuit coupled to the FFT circuit that includes:
a first adder that includes:
a first input coupled to receive a first sample of the FFT output set;
a second input; and
an output;
a first conjugate circuit that includes an input coupled to receive a second sample of the FFT output set and includes an output coupled to the second input of the first adder;
a first negation circuit that includes an input coupled to receive the first sample and includes an output;
a second adder that includes:
a first input coupled to the output of the first negation circuit;
a second input coupled to the output of the first conjugate circuit; and
an output;
a first multiplier that includes an input coupled to the output of the second adder and includes an output;
a second multiplier that includes:
a first input coupled to the output of the first adder;
a second input; and
an output;
a table memory coupled to the second input of the second multiplier;
a third adder that includes:
a first input coupled to the output of the second multiplier;
a second input coupled to the output of the first multiplier; and
an output configured to provide a first sample of an output set of complex samples;
a second conjugate circuit that includes an input coupled to the output of the first multiplier and includes an output;
a third conjugate circuit that includes an input coupled to the output of the second multiplier and includes an output;
a second negation circuit that includes an input coupled to the output of the third conjugation circuit and includes an output; and
a fourth adder that includes:
a first input coupled to the output of the second conjugate circuit;
a second input coupled to the output of the second negation circuit; and
an output configured to provide a second sample of the output set of complex samples.

2. The circuit device of claim 1, wherein a set of real values is encoded in the input set of complex samples such that even indexed values of the set of real values are encoded in real portions of the input set of complex samples and odd indexed values of the set of real values are encoded in imaginary portions of the input set of complex samples.

3. The circuit device of claim 1, wherein a set of real values is encoded in the input set of complex samples such that odd indexed values of the set of real values are encoded in real portions of the input set of complex samples and even indexed values of the set of real values are encoded in imaginary portions of the input set of complex samples.

4. The circuit device of claim 1, further comprising:
a first memory having an input and an output, the input of the first memory coupled to the output of the FFT circuit, and the output of the first memory coupled to the first input of the first adder; and
a second memory having an input and an output, the input of the second memory coupled to the output of the FFT circuit, and the output of the second memory coupled to the input of the first conjugate circuit.

5. The circuit device of claim 4, further comprising a delay circuit having an input and an output, the input of the delay circuit either coupled between to the output of the first memory and the first input of the first adder, or coupled between the output of the second memory and the input of the conjugate circuit.

6. The circuit device of claim 1, further comprising a delay circuit having an input and an output, the input of the delay circuit coupled to either the output of the third adder or the output of the fourth adder.

7. The circuit device of claim 1, further comprising:
first and second demultiplexers each respectively having a first input, a first output, and a second output, the first demultiplexer coupled to an output of the FFT circuit, and the second demultiplexer coupled to an output of the combiner circuit; and
first and second multiplexers each respectively having a first input, a second input, and an output, the first multiplexer coupled between the first output of the first demultiplexer and an input of the combiner circuit, and the second multiplexer coupled between the first output of the second demultiplexer and an input of the FFT circuit;
wherein the first and second multiplexers and the first and second demultiplexers are configured to, responsive to a first mode select signal, couple an output of the FFT circuit to an input of the combiner circuit; and
wherein the first and second multiplexers and the first and second demultiplexers are configured to, responsive to a second mode select signal, couple an output of the combiner circuit to an input of the FFT circuit.

8. An integrated circuit (IC), comprising:
a fast Fourier transform (FFT) circuit;
a first memory coupled to the FFT circuit;
a second memory coupled to the FFT circuit;
a conjugate symmetric combiner coupled to the first memory, the second memory, and the FFT circuit; and
a control circuit coupled to the first memory, the second memory, the FFT circuit, and the conjugate symmetric combiner, and configured to:
control the FFT circuit to receive and process a first stream of samples to generate a second stream of samples;
in a first phase, control the FFT circuit to provide a first portion of the second stream of samples to the first memory; and
in a second phase, control the FFT circuit to provide a second portion of the second stream of samples to the second memory, control the first memory to provide the first portion of the second stream of samples to the conjugate symmetric combiner, and control the conjugate symmetric combiner to generate a third stream of samples responsive to the first portion of the second stream of samples.

9. The IC of claim 8, wherein the control circuit is configured to:
in a third phase, control the FFT circuit to provide a third portion of the second stream of samples to the conjugate symmetric combiner, control the second memory to provide the second portion of the second stream of samples to the conjugate symmetric combiner, control the conjugate symmetric combiner to generate a fourth stream of samples responsive to the second and third portions of the second stream of samples, and control the conjugate symmetric combiner to provide a first portion of the fourth stream of samples to the first memory.

10. The IC of claim 8, wherein the first memory and the second memory each respectively has a first output and a second output, and the conjugate symmetric combiner has a first input and a second input, the IC further comprising:
a delay circuit having an input and an output, the input of the delay circuit coupled to the first outputs of the first and second memories, the output of the delay circuit coupled to the first input of the conjugate symmetric combiner, and the second outputs of the first and second memories coupled to the second input of the conjugate symmetric combiner.

11. The IC of claim 8, wherein the conjugate symmetric combiner has a first output and a second output, the IC further comprising:
a delay circuit having an input and an output, the input of the delay circuit coupled to the first output of the conjugate symmetric combiner.

12. The IC of claim 8, wherein the FFT circuit is a serial pipelined FFT circuit.

13. The IC of claim 8, wherein the FFT circuit is a radix-2 FFT circuit or a radix-3 FFT circuit.

14. The IC of claim 8, wherein the FFT circuit, the first memory, the second memory, and the conjugate symmetric combiner together selectably perform a real-valued FFT, a complex-valued FFT, a real-valued inverse FFT (IFFT), or a complex-valued IFFT, responsive to a selected mode of the control circuit.

15. The IC of claim 8, wherein the first memory and the second memory are included in a third memory that has an input, the conjugate symmetric combiner has an output, and the FFT circuit has an input and an output, the IC further comprising:
a first demultiplexer having an input, a first output, and a second output;
a first multiplexer having a first input, a second input, and an output, the first input of the first multiplexer coupled to the first output of the first demultiplexer, and the output of the first multiplexer coupled to the input of the FFT circuit;
a second multiplexer having a first input, a second input, and an output, the second input of the second multiplexer coupled to the second output of the first demultiplexer, and the output of the second multiplexer coupled to the input of the third memory;
a second demultiplexer having an input, a first output, and a second output, the input of the second demultiplexer coupled to the output of the FFT circuit, and the first output of the second demultiplexer coupled to the first input of the second multiplexer;
a third multiplexer having a first input, a second input, and an output, the second input of the third multiplexer coupled to the second output of the second demultiplexer; and
a third demultiplexer having an input, a first output, and a second output, the input of the third demultiplexer coupled to the output of the conjugate symmetric combiner, the first output of the third demultiplexer coupled to the first input of the third multiplexer, and the second output of the third demultiplexer coupled to the second input of the first multiplexer.

16. The IC of claim 8,
wherein the first phase and the second phase correspond to a real mode of the control circuit;
wherein the control circuit is configured to selectably switch between the real mode of the control circuit and a complex mode of the control circuit; and
wherein in the complex mode of the control circuit a data path that includes the FFT circuit does not include the conjugate symmetric combiner.

17. An integrated circuit (IC), comprising:
a first memory;
a second memory;
a conjugate symmetric combiner coupled to the first memory and the second memory;
a fast Fourier transform (FFT) circuit coupled to the conjugate symmetric combiner and the second memory; and
a control circuit coupled to the first memory, the second memory, the FFT circuit, and the conjugate symmetric combiner, and configured to:
in a first phase, control the first memory to receive a first stream of samples; and
in a second phase, control the first memory to provide the first stream of samples to the conjugate symmetric combiner, control the conjugate symmetric combiner to receive a second stream of samples, control the conjugate symmetric combiner to generate a third stream of samples responsive to the first and second streams of samples, and control the conjugate symmetric combiner to provide a first portion of the third stream of samples to the FFT circuit and provide a second portion of the third stream of samples to the second memory.

18. The IC of claim 17, wherein the samples of the third stream of samples are complex samples, further comprising a complex conjugate block coupled between the conjugate symmetric combiner and the FFT circuit.

19. The IC of claim 17, wherein the control circuit is configured to:
in iterations of the first phase after a first iteration of the first phase, control the first memory to receive the first stream of samples, and control the second memory to provide the second portion of the third stream of samples to the FFT circuit.

20. An integrated circuit (IC), comprising:
a fast Fourier transform (FFT) circuit;
a first memory coupled to the FFT circuit coupled to the FFT circuit;
a second memory coupled to the FFT circuit coupled to the FFT circuit;
a conjugate symmetric combiner coupled to the first memory, the second memory, and the FFT circuit; and
a control circuit coupled to the first memory, the second memory, the FFT circuit, and the conjugate symmetric combiner, and configured to control the first memory, the second memory, the FFT circuit, and the conjugate symmetric combiner to:
receive a stream of samples; and
perform a real FFT, a complex FFT, a real inverse FFT, or a complex FFT responsive to a mode selection.

21. The IC of claim 20, wherein the control circuit is configured to, in a real FFT mode:
control the FFT circuit to receive and process a first stream of samples to generate a second stream of samples;
in a first phase, control the FFT circuit to provide a first portion of the second stream of samples to the first memory; and
in a second phase, control the FFT circuit to provide a second portion of the second stream of samples to the second memory, control the first memory to provide the first portion of the second stream of samples to the conjugate symmetric combiner, and control the conjugate symmetric combiner to generate a third stream of samples responsive to the first portion of the second stream of samples.

22. The IC of claim 21, wherein the control circuit is configured to, in the real FFT mode:
in a third phase, control the FFT circuit to provide a third portion of the second stream of samples to the conjugate symmetric combiner, control the second memory to provide the second portion of the second stream of samples to the conjugate symmetric combiner, control the conjugate symmetric combiner to generate a fourth stream of samples responsive to the second and third portions of the second stream of samples, and control the conjugate symmetric combiner to provide a first portion of the fourth stream of samples to the first memory.

23. The IC of claim 20, wherein the first memory and the second memory each respectively has a first output and a second output, and the conjugate symmetric combiner has a first input and a second input, the IC further comprising:
a delay circuit having an input and an output, the input of the delay circuit coupled to the first outputs of the first and second memories, the output of the delay circuit coupled to the first input of the conjugate symmetric combiner, and the second outputs of the first and second memories coupled to the second input of the conjugate symmetric combiner.

24. The IC of claim 20, wherein the conjugate symmetric combiner has a first output and a second output, the IC further comprising:
a delay circuit having an input and an output, the input of the delay circuit coupled to the first output of the conjugate symmetric combiner.

25. The IC of claim 20, wherein the FFT circuit is a serial pipelined FFT circuit.

26. The IC of claim 20, wherein the FFT circuit is a radix-2 FFT circuit or a radix-3 FFT circuit.

27. The IC of claim 20, wherein, in a complex FFT mode or a complex IFFT mode of the control circuit, a data path that includes the FFT circuit does not include the conjugate symmetric combiner.
